(19) United States
(12) Patent Application Publication
(10) Pub. No.: US 2017/0291983 A1
(43) Pub. Date: Oct. 12, 2017

(54) POLYOLS FORMED FROM SELF-METATHESIZED NATURAL OILS AND THEIR USE IN MAKING POLYURETHANE FOAMS

(71) Applicant: TRENT UNIVERSITY, Peterborough (CA)

(72) Inventors: Suresh Narine, Peterborough (CA); Shaojun Li, Peterborough (CA); Laziz Bouzidi, Peterborough (CA)

(21) Appl. No.: 15/483,093

(22) Filed: Apr. 10, 2017

Related U.S. Application Data
(60) Provisional application No. 62/320,700, filed on Apr. 11, 2016.

(51) Int. Cl. C08G 18/67; C08G 18/08; C08G 18/18; C08J 9/12; C08G 18/24; C11C 3/00; C08G 18/76

(52) U.S. Cl. CPC C08G 18/675; C11C 3/00; C11C 3/006; C08G 18/14; C08G 18/7671; C08J 9/122; C08G 18/246; C08G 18/1825; C08G 2101/0008

(57) ABSTRACT

The disclosure generally provides methods of making natural oil-derived polyol compounds from compositions that include self-metathesized oligomers of natural oils, including methods of using such polyols to make polyurethane compositions, such as polyurethane foams.

### TECHNICAL FIELD

The disclosure generally provides methods of making natural oil-derived polyol compounds from compositions that include self-metathesized oligomers of natural oils, including methods of using such polyols to make polyurethane compositions, such as polyurethane foams.

### DESCRIPTION OF RELATED ART

Polyurethanes are one of the most versatile polymeric materials with regards to both processing methods and mechanical properties. Polyurethanes are formed either based on the reaction of NCO groups and hydroxyl groups, or via non-isocyanate pathways, such as the reaction of cyclic carbonates with amines, self-polycondensation of hydroxyl-acyl azides or melt transurethane methods. The most common method of urethane production is via the reaction of a polyol and an isocyanate which forms the backbone urethane group. Cross-linking agents, chain extenders, blowing agents and other additives may also be added as needed. The proper selection of reactants enables a wide range of polyurethane elastomers, sheets, foams, and the like.

Traditionally, petroleum-derived polyols have been widely used in the manufacturing of polyurethane foams. However, there has been an increased interest in the use of renewable resources in the manufacturing of polyurethane foams. This has led to research into developing natural oil-based polyols for use in the manufacturing of foams.

Natural oils, such as soybean oil, have been used to make polyols for use in polyurethane applications. But these materials suffer from certain limitations. Therefore, there is a continuing need to discover new ways of developing polyols derived from natural sources.

### SUMMARY

The present disclosure overcomes one or more of the problems associated with traditional natural oil-based polyols by employing oligomeric forms of natural oils, which have a higher molecular weight than typical natural oil compounds (e.g., triglycerides).

In certain embodiments, self-metathesized soybean oil (MSBO)-derived polyols were prepared using a one-pot two-step reaction: epoxidation and hydroxylation. In some embodiments, the OH value of the resulting MSBO polyols were controlled from 98.7 to 263 mg KOH/g by varying the amount of hydrogen peroxide (30 g-140 g) used and the reaction conditions were varied by providing an external cooling system or running the reaction without any external cooling. In some such embodiments, the potential side reaction which can occur and lead to formic acid units attaching to the polyol backbone was prevented when a cooling water bath was employed during the epoxidation reaction. In certain embodiments, the crystallization onset of MSBO polyols with OH values of less than 200 mg KOH/g was lower than 21° C., a highly beneficial characteristic as it allows for the polymerization of these polyols at room temperature.

In some such embodiments, flexible polyurethane foams were prepared from MSBO polyols and MDI (methylene diphenyl diisocyanate), and their thermal properties were investigated with TGA and DSC and their mechanical properties determined with a texture analyzer. In some embodiments, the polyurethane foams were stable at temperatures as high as 250° C. A wide range of strengths for flexible foams was achieved with the MSBO polyols. In some embodiments, the stress at 10% deformation of the MSBO polyol derived flexible foam (density ˜150 Kg/m³) varied from 0.065 MPa to 0.75 MPa with varying OH value of the MSBO polyols. The degree of recovery post stress also depended predictably on the foam strength, with the PU foam with the lowest strength demonstrating the highest recovery. In some embodiments, the polyurethane foams demonstrated better recovery properties in comparison to polyols based on non-oligomerized natural oil derivatives. This difference in properties is attributed to the higher oligomeric content of the MSBO polyols compared to the PMTAG polyol.

In a first aspect, the disclosure provides methods of making a natural oil-derived polyol, the method comprising: providing a metathesized natural oil composition, which comprises metathesis oligomers of unsaturated natural oil glycerides, wherein the metathesis oligomers comprise one or more carbon-carbon double bonds, and are formed by reacting two or more unsaturated natural oil glycerides in the presence of a metathesis catalyst; and reacting at least one of the one or more carbon-carbon double bonds in the metathesis oligomers to form a polyol.

In a second aspect, the disclosure provides polyols, which are made by methods of the first aspect.

In a third aspect, the disclosure provides methods of forming a polyurethane composition, comprising: providing a polyol of the second aspect and an organic diisocyanate; and reacting the polyol and the organic diisocyanate to form a polyurethane composition.

Further aspects and embodiments are disclosed in the Detailed Description.

### BRIEF DESCRIPTION OF THE DRAWINGS

The following drawings are provided for purposes of illustrating various embodiments of the compounds, compositions, and methods disclosed herein. The drawings are provided for illustrative purposes only, and are not intended to describe any preferred compounds, preferred compositions, or preferred methods, or to serve as a source of any limitations on the scope of the claimed inventions.

FIG. 1 shows one embodiment of a metathesis dimer formed by the methods disclosed herein.

FIG. 2 shows one embodiment of a metathesis trimer formed by the methods disclosed herein.

FIG. 3 shows one embodiment of a metathesis tetramer formed by the methods disclosed herein.

FIG. 4 shows the representation of olefin metathesis reaction.

FIG. 5 shows an example of the self-metathesis of the soybean oil, where n is the number of monomers in the oligomer level (n=1 represents triacylglyceride (TAG) monomer, n=2, dimer, n=3, trimer, n=4, quatrimer or tetramer, etc.); RCOOH=stearic acid (S), palmitic acid (P), linolenic acid (Ln), oleic acid (O), linoleic acid (L). Double bonds in R include cis- and trans- configurations such as in elaidic acid (E).

FIG. 6 shows an example of the general formation of urethane linkage between isocyanate groups and OH groups.

FIG. 7 shows an example of a blowing reaction during the polymerization process.

FIG. 8 shows the ¹H-NMR spectrum for MSBO polyol identified as PW-30.

FIG. 9 shows the ¹H-NMR spectrum for MSBO polyol identified as PW-45.

FIG. 10 shows the ¹H-NMR spectrum for MSBO polyol identified as PW-140.

FIG. 11 shows the ¹H-NMR spectrum for MSBO polyol identified as PWO-30.

FIG. 12 shows the ¹H-NMR spectrum for MSBO polyol identified as PWO-45.

FIG. 13 shows the ¹H-NMR spectrum for MSBO polyol identified as PWO-140.

FIG. 14 shows the DSC (a) cooling and (b) melting profiles (both at 5.0° C./min) of MSBO Polyols. The curves are labelled with the sample codes of Table 2.

FIG. 15 shows DTG profiles of MSBO polyols. The curves are labeled with the sample codes of Table 2.

FIG. 16 shows FTIR spectra of MSBO Polyol Foams. The curves are labelled with the sample codes of Table 2.

FIG. 17 shows TGA curves of MSBO polyol Polyurethane foams. The curves are labelled with the sample codes of Table 2.

FIG. 18 shows DSC heating profiles of MSBO polyol polyurethane flexible foams.

FIG. 19 shows Percentage of recovery of flexible MSBO Polyol foams. : PW-30; ▪: PW-45; ▴: PW-140; ◯: PWO-30. Dashed lines are guides for the eye.

FIG. 20. shows SEM images of the MSBO polyurethane foams.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “reaction” and “reacting” refer to the conversion of a substance into a product, irrespective of reagents or mechanisms involved.

As used herein, “oligomer” refers to a substance having a chemical structure that includes the multiple repetition of constitutional units formed from substances of lower relative molecular mass relative to the molecular mass of the oligomer. In some embodiments, the oligomer contains from 2 up to 100 constitutional units.

As used herein, “natural oil,” refer to oils derived from plants or animal sources. These terms include natural oil derivatives, unless otherwise indicated. The terms also include modified plant or animal sources (e.g., genetically modified plant or animal sources), unless indicated otherwise. Examples of natural oils include, but are not limited to, vegetable oils, algae oils, fish oils, animal fats, tall oils, derivatives of these oils, combinations of any of these oils, and the like. Representative non-limiting examples of vegetable oils include rapeseed oil (canola oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, and castor oil. Representative non-limiting examples of animal fats include lard, tallow, poultry fat, yellow grease, and fish oil. Tall oils are by-products of wood pulp manufacture. In some embodiments, the natural oil or natural oil feedstock comprises one or more unsaturated glycerides (e.g., unsaturated triglycerides). In some such embodiments, the natural oil feedstock comprises at least 50% by weight, or at least 60% by weight, or at least 70% by weight, or at least 80% by weight, or at least 90% by weight, or at least 95% by weight, or at least 97% by weight, or at least 99% by weight of one or more unsaturated triglycerides, based on the total weight of the natural oil feedstock.

As used herein, “natural oil derivatives” refers to the compounds or mixtures of compounds derived from a natural oil using any one or combination of methods known in the art. Such methods include but are not limited to saponification, fat splitting, transesterification, esterification, hydrogenation (partial, selective, or full), isomerization, oxidation, and reduction. Representative non-limiting examples of natural oil derivatives include gums, phospholipids, soapstock, acidulated soapstock, distillate or distillate sludge, fatty acids and fatty acid alkyl ester (e.g. non-limiting examples such as 2-ethylhexyl ester), hydroxy substituted variations thereof of the natural oil. For example, the natural oil derivative may be a fatty acid methyl ester (“FAME”) derived from the glyceride of the natural oil. In some embodiments, a feedstock includes canola or soybean oil, as a non-limiting example, refined, bleached, and deodorized soybean oil (i.e., RBD soybean oil). Soybean oil typically comprises about 95% weight or greater (e.g., 99% weight or greater) triglycerides of fatty acids. Major fatty acids in the polyol esters of soybean oil include saturated fatty acids, as a non-limiting example, palmitic acid (hexadecanoic acid) and stearic acid (octadecanoic acid), and unsaturated fatty acids, as a non-limiting example, oleic acid (9-octadecenoic acid), linoleic acid (9,12-octadecadienoic acid), and linolenic acid (9,12,15-octadecatrienoic acid).

As used herein, the term “natural oil glyceride” refers to a glyceryl ester naturally occurring fatty acids, such as those found in one or more of vegetable oils, algal oils, fish oils, animal fats, or tall oils, where representative non-limiting examples of vegetable oils include rapeseed oil (canola oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, and castor oil, and representative non-limiting examples of animal fats include lard, tallow, poultry fat, and yellow grease. As used herein, the term “unsaturated natural oil glyceride” refers to such natural oil glycerides in which contain one or more fatty acid moieties that have a carbon-carbon double bond. Non-limiting examples include glycerides of oleic acid, linoleic acid, or linolenic acid. Such glycerides can include monoacylglycerides, diacylglycerides, and triacylglycerides.

As used herein, “metathesis catalyst” includes any catalyst or catalyst system that catalyzes an olefin metathesis reaction.

As used herein, “metathesize” or “metathesizing” refer to the reacting of a feedstock in the presence of a metathesis catalyst to form a “metathesized product” comprising new olefinic compounds, i.e., “metathesized” compounds. Metathesizing is not limited to any particular type of olefin metathesis, and may refer to cross-metathesis (i.e., co-metathesis), self-metathesis, ring-opening metathesis, ring-opening metathesis polymerizations (“ROMP”), ring-closing metathesis (“RCM”), and acyclic diene metathesis (“ADMET”). In some embodiments, metathesizing refers to reacting two triglycerides present in a natural feedstock (self-metathesis) in the presence of a metathesis catalyst, wherein each triglyceride has an unsaturated carbon-carbon double bond, thereby forming a new mixture of olefins and esters which may include a triglyceride dimer. Such triglyceride dimers may have more than one olefinic bond, thus higher oligomers also may form. Additionally, in some other embodiments, metathesizing may refer to reacting an olefin, such as ethylene, and a triglyceride in a natural feedstock having at least one unsaturated carbon-carbon double bond, thereby forming new olefinic molecules as well as new ester molecules (cross-metathesis).

As used herein, “polyurethane” refers to a polymer comprising two or more urethane (or carbamate) linkages. Other types of linkages can be included, however. For example, in some instances, the polyurethane or polycarbamate can contain urea linkages, formed, for example, when two isocyanate groups can react. In some other instances, a urea or urethane group can further react to form further groups, including, but not limited to, an allophanate group, a biuret group, or a cyclic isocyanurate group. In some embodiments, at least 70%, or at least 80%, or at least 90%, or at least 95% of the linkages in the polyurethane or polycarbamate are urethane linkages. Further, in the context of a block copolymer, the term “polyurethane block copolymer” refers to a block copolymer, where one or more of the blocks are a polyurethane or a polycarbamate. Other blocks in the “polyurethane block copolymer” may contain few, if any, urethane linkages. For example, in some polyurethane block copolymers, at least one of the blocks is a polyether or a polyester and one or more other blocks are polyurethanes or polycarbamates.

As used herein, “isocyanate” or “isocyanates” refer to compounds having the general formula: R—NCO, wherein R denotes any organic moiety (such as alkyl, aryl, or silyl groups), including those bearing heteroatom-containing substituent groups. In certain embodiments, R denotes alkyl, alkenyl, aryl, or alcohol groups. In certain embodiments, the term “isocyanate” or “isocyanates” may refer to a group of compounds with the general formula described above, wherein the compounds have different carbon lengths. The term “isocyanato” refers to a —NCO moiety. In some cases, an isocyanate can have more than two or more isocyanato groups. As used herein, “diisocyanate” and “polyisocyanate” refer to isocyanates having two or more isocyanato groups. The term “organic diisocyanate” refers to compounds having the general formula OCN—R′—NCO, where R′ is an organic group containing at least one carbon atom, and which, in some embodiments, contain other isocyanate substituents.

The terms “group” or “moiety” refers to a linked collection of atoms or a single atom within a molecular entity, where a molecular entity is any constitutionally or isotopically distinct atom, molecule, ion, ion pair, radical, radical ion, complex, conformer etc., identifiable as a separately distinguishable entity.

As used herein, “mix” or “mixed” or “mixture” refers broadly to any combining of two or more compositions. The two or more compositions need not have the same physical state; thus, solids can be “mixed” with liquids, e.g., to form a slurry, suspension, or solution. Further, these terms do not require any degree of homogeneity or uniformity of composition. This, such “mixtures” can be homogeneous or heterogeneous, or can be uniform or non-uniform. Further, the terms do not require the use of any particular equipment to carry out the mixing, such as an industrial mixer.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A1 and A2, then one or more members of the class can be present concurrently.

As used herein, the various functional groups represented will be understood to have a point of attachment at the functional group having the hyphen or dash (—) or an asterisk (*). In other words, in the case of —CH₂CH₂CH₃, it will be understood that the point of attachment is the CH₂ group at the far left. If a group is recited without an asterisk or a dash, then the attachment point is indicated by the plain and ordinary meaning of the recited group.

In some instances herein, organic compounds are described using the “line structure” methodology, where chemical bonds are indicated by a line, where the carbon atoms are not expressly labeled, and where the hydrogen atoms covalently bound to carbon (or the C-H bonds) are not shown at all. For example, by that convention, the formula

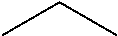

represents n-propane.

As used herein, multi-atom bivalent species are to be read from left to right. For example, if the specification or claims recite A-D-E and D is defined as —OC(O)—, the resulting group with D replaced is: A-OC(O)-E and not A-C(O)O-E.

Unless a chemical structure expressly describes a carbon atom as having a particular stereochemical configuration, the structure is intended to cover compounds where such a stereocenter has an R or an S configuration.

Other terms are defined in other portions of this description, even though not included in this subsection.

Polyols from Self-Metathesized Natural Oils

In one aspect, the disclosure provides methods of making a natural oil-derived polyol, the methods comprising: providing a metathesized natural oil composition, which comprises metathesis oligomers of unsaturated natural oil glycerides, wherein the metathesis oligomers comprise one or more carbon-carbon double bonds, and are formed by reacting two or more unsaturated natural oil glycerides in the presence of a metathesis catalyst; and reacting at least one of the one or more carbon-carbon double bonds in the metathesis oligomers to form a polyol.

### Self-Metathesized Natural Oils

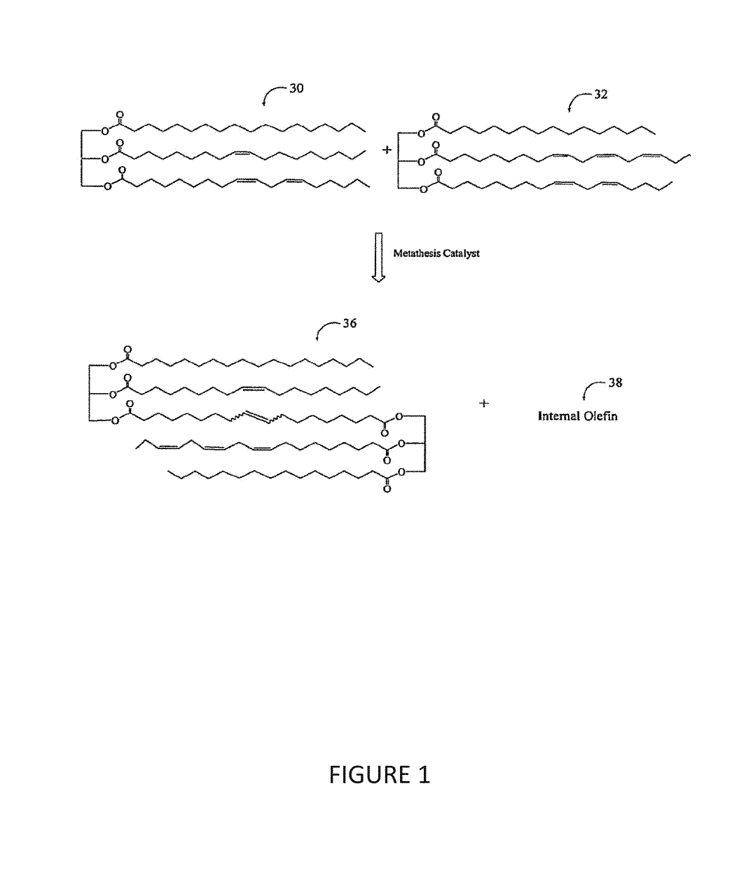

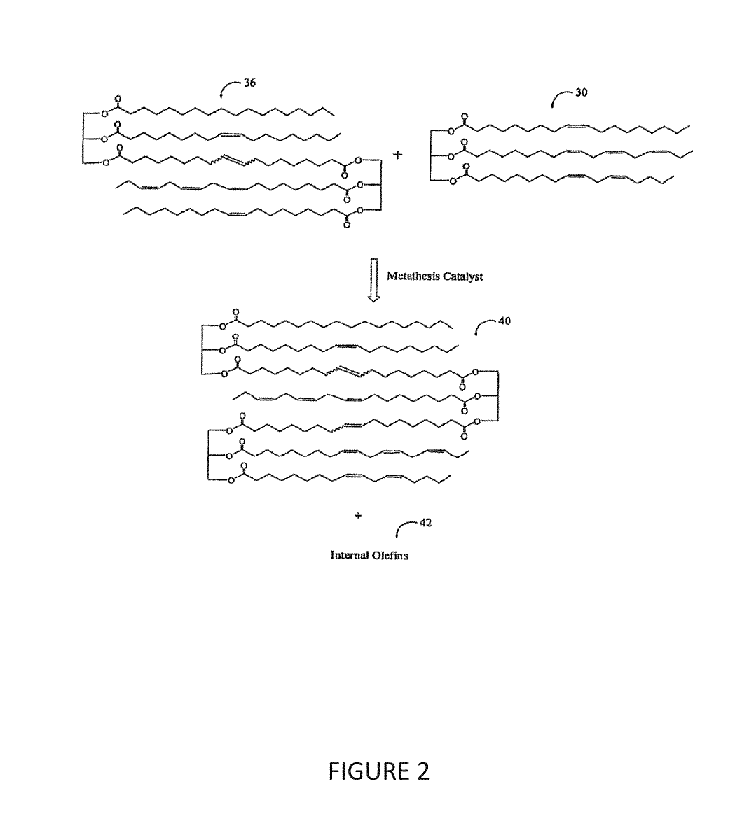

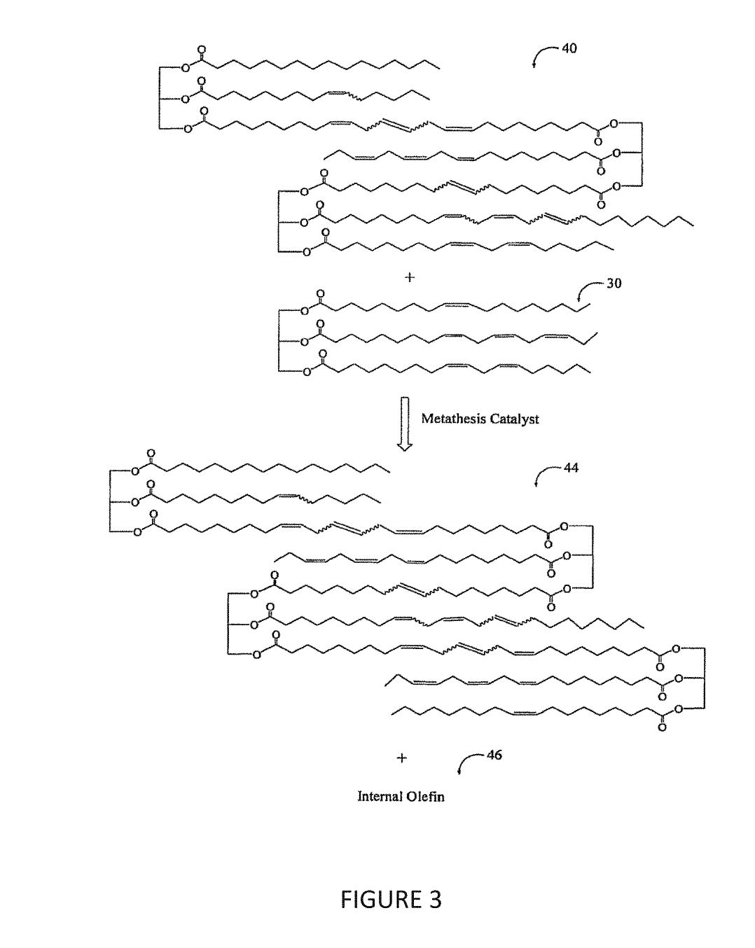

In a first step, the methods include providing a metathesized natural oil composition, which comprises metathesis oligomers of unsaturated natural oil glycerides. As used herein, “providing” is given its broadest reasonable interpretation, including, but not limited to, delivering the composition, synthesizing the composition, formulating the composition, and the like. The metathesis oligomers are formed by reacting two or more unsaturated natural oil glycerides in the presence of a metathesis catalyst. As noted in the definitions, metathesis reactions involve an exchange of substituents between two carbon-carbon double bonds. Thus, oligomers can form when one of the carbon-carbon double bonds of one unsaturated natural oil glyceride react with one of the carbon-carbon double bonds of another unsaturated natural oil glyceride to form a dimer of two unsaturated natural oil glyceride compounds. Then, for example, that dimer can react with another unsaturated natural oil glyceride compound to form a trimer, which can then react with another unsaturated natural oil glyceride to form a tetramer, and so on. FIG. 1 shows a non-limiting example of a reaction for forming a metathesis dimer of unsaturated natural oil glycerides (in this case, triacylglycerides). A first unsaturated natural oil glyceride 30 is reacted with a second unsaturated natural oil glyceride 32 in the presence of a metathesis catalyst to form a metathesis dimer 36 and an internal olefin byproduct 38. FIG. 2 shows a non-limiting example of a reaction for forming a metathesis trimer of unsaturated natural oil glycerides (in this case, triacylglycerides). A metathesis dimer 36 is reacted with an unsaturated natural oil glyceride 30 in the presence of a metathesis catalyst to form a metathesis trimer 40 and an internal olefin byproduct 42. FIG. 3 shows a non-limiting example of a reaction for forming a metathesis tetramer of unsaturated natural oil glycerides (in this case, triacylglycerides). A metathesis trimer 40 is reacted with an unsaturated natural oil glyceride 30 in the presence of a metathesis catalyst to form a metathesis tetramer 44 and an internal olefin byproduct 46. Further examples are provided in U.S. Pat. No. 8,815,257, which is incorporated herein by reference.

The methods disclosed herein can employ metathesis oligomers having any suitable distribution of dimers, trimers, tetramers, and the like. In some embodiments, metathesis dimers are present in an amount from 10 percent by weight to 60 percent by weight, or from 20 percent by weight to 30 percent by weight, based on the total weight of metathesis oligomers in the metathesized natural oil composition. In some embodiments, metathesis trimers and higher-order oligomers are present in an amount from 40 percent by weight to 80 percent by weight, or from 50 percent by weight to 70 percent by weight, based on the total weight of metathesis oligomers in the metathesized natural oil composition. In some embodiments, the metathesis oligomers include metathesis oligomers having from 2 to 20, or from 2 to 10, unsaturated natural oil glyceride units.

The metathesis oligomers can be formed from any suitable glycerides, including triacylglycerides, diacylglycerides, monoacylglycerides, or any mixtures thereof. In some such embodiments, the unsaturated natural oil glycerides are triacylglycerides.

The metathesis oligomers can be formed from the unsaturated natural oil glycerides of any natural oil, including, but not limited to, a vegetable oil, an algal oil, a fish oil, an animal fat, a tall oil, or any mixtures thereof. In some embodiments, the metathesis oligomers are formed from unsaturated natural oil glycerides of a vegetable oil. Non-limiting examples of suitable vegetable oils include canola oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, castor oil, or any mixtures thereof. In some embodiments, the vegetable oil is canola oil, palm oil, soybean oil, or a mixture thereof In some further embodiments, the vegetable oil is soybean oil.

The metathesized natural oil composition can include other components, which may or may not participate in the subsequent reacting step. For example, in some embodiments, the metathesized natural oil compositions includes a certain amount of unsaturated natural oil glyceride monomers. In some embodiments, the amount of such monomers is relatively low. For example, in some embodiments, such monomers are present in the metathesized natural oil composition in an amount no greater than 25 percent by weight, or no greater than 20 percent by weight, or no greater than 15 percent by weight, or no greater than 10 percent by weight, based on the total weight of monomer and metathesis oligomers in the metathesized natural oil composition. In some embodiments, the metathesized natural oil composition can also include alkenes and other hydrocarbons, which, for example, form as byproducts of the self-metathesis reactions, and which may not be fully removed following the reaction.

### Olefin Metathesis of Soybean Oil

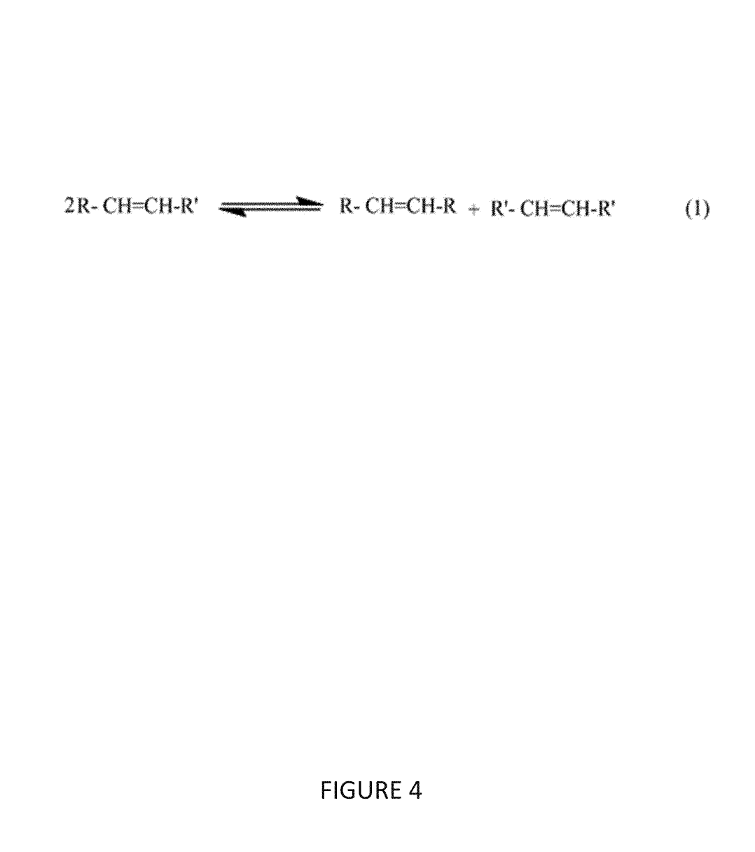

Olefin metathesis is an important organic synthesis technique that is increasingly used in oleochemistry to produces novel chemicals, many of which serve as or are potential petrochemical replacements. It is a powerful tool that can increase the molecular diversify and reactivity of natural oils and fats dramatically. Olefin metathesis is a reversible reaction involving the exchange of alkylidene groups between the reactant alkene moieties in the presence of catalysts, typically transition metal complexes. A sample reaction is shown in FIG. 4, where R and R′ are organic groups. The metal catalyst for metathesis reaction can be alkylidene (or carbene) complexes of transition metals, particularly Ru, Mo, or W, as discussed in further detail below.

Olefin metathesis is further categorized as self-metathesis and cross metathesis. Self-metathesis (forward reaction in the scheme shown in FIG. 4) is the process in which the same olefin molecules react to produce two different olefin products; whereas, cross metathesis (backward reaction in the scheme shown in FIG. 4) is the process in which two different olefins are involved to produce a new olefin product. The self-metathesis of TAGs, such as soybean oil and triolein, results in a complex mixture comprising linear oligomers (from dimer to pentamer), macrocyclic structures, and cross-linked polymers, as well as trans-/cis isomers. The actual composition of a metathesis product is highly dependent on the reaction conditions, such as starting materials, temperature, and type of catalyst, etc., giving the possibility to control the product composition.

### Composition of MSBO

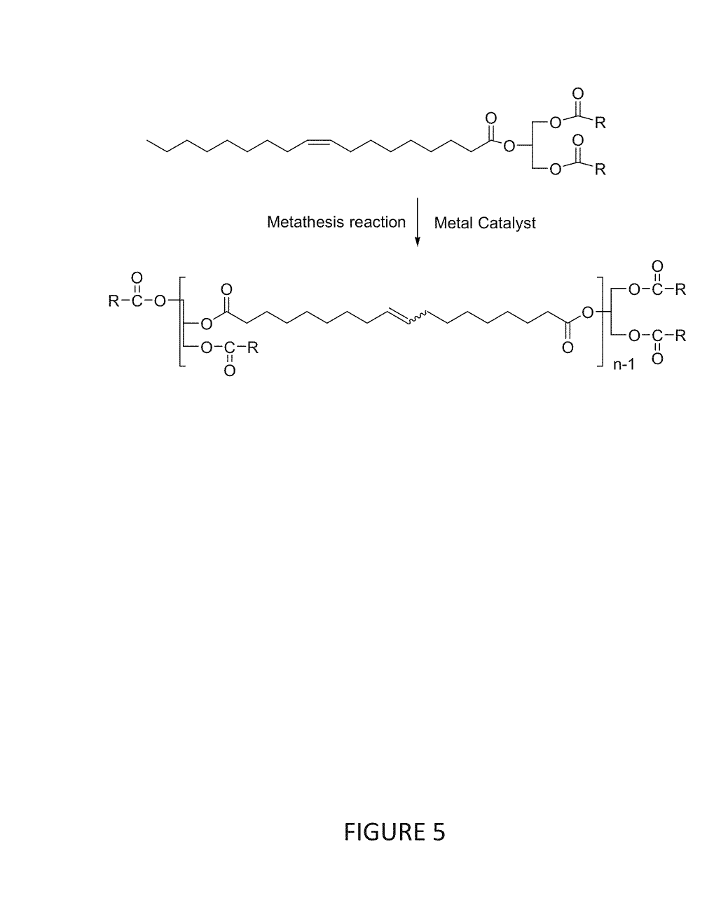

In certain embodiments, the starting material of the present disclosure is a self-metathesized soybean oil (MSBO). In certain embodiments, the self-metathesis reaction was conducted in the presence of Grubbs second generation catalyst (Ru catalyst). An example of metathesis reaction of soybean oil is presented in the scheme shown in FIG. 5.

A number of approaches were utilized to determine the composition of MSBO. Due to the complexity of MSBO, only “families” of compounds were separated by column chromatography. GPC, HPLC and MS methods were developed for analysing the composition of the MSBO fractions. The results of this effort are previously reported in Mohanan et al., Energy vol. 96, pp. 335-345. Some possible compounds in the metathesized soybean oil (MSBO) are listed in Table 1. In some embodiments, MSBO oligomers are composed of the TAG structures of the starting soybean oil and have saturated fatty acids (˜14% in total) as well as unsaturated fatty acids. The newly formed carbon-carbon double bonds can have any suitable trans-to-cis ratio. In some embodiments, the trans-to-cis ratio of the metathesis oligomers, as determined by ¹H-NMR ranges from 3 to 10, or from 4 to 9, or from 4.4 to 8.

TABLE 1
Fractions collected from MSBO column chromatography and their
Compositional analysis. Component structures are those detected
by ¹H-NMR. Molecular weight (weight-average) (Mw) was
measured by GPC using calibration curves of pure TAG-oligomers
standards. Amount (A %) is based on 25 g of sample.

| Family | A (%) | Mw (g/mol) | Components |
|---|---|---|---|
| MSBO-F1 | 5.6 | — | Alkene |
| MSBO-F2 | 7.9 | 750-1062 | Monomers |
| MSBO-F3 | 30.0 | 1347-1648 | Dimers |
| MSBO-F4 | 49.8 | 2060-2775 | Trimer + quatrimer |
| MSBO-F5 | 2.0 | — | Polymeric materials (pentamer and |
| | | | higher) |

### Metathesis Catalysis

In some embodiments, after any optional pre-treatment of the natural oil, the natural oil is reacted in the presence of a metathesis catalyst in a metathesis reactor. In some such embodiments, an unsaturated ester (e.g., an unsaturated glyceride, such as an unsaturated triglyceride) is reacted in the presence of a metathesis catalyst in a metathesis reactor. In some embodiments, these unsaturated esters are unsaturated natural oil glycerides, according to any of the above embodiments.

In some embodiments, the metathesis comprises reacting a natural oil feedstock (or another unsaturated ester) in the presence of a metathesis catalyst. In some such embodiments, the metathesis comprises reacting one or more unsaturated glycerides (e.g., unsaturated natural oil glycerides) in the natural oil feedstock in the presence of a metathesis catalyst. In some embodiments, the unsaturated natural oil glyceride comprises one or more esters of oleic acid, linoleic acid, linoleic acid, or combinations thereof. In some other embodiments, the unsaturated glyceride is the product of the partial hydrogenation and/or the metathesis of another unsaturated glyceride (as described above).

The metathesis process can be conducted under any conditions adequate to produce the desired metathesis products. For example, stoichiometry, atmosphere, solvent, temperature, and pressure can be selected by one skilled in the art to produce a desired product and to minimize undesirable byproducts. In some embodiments, the metathesis process may be conducted under an inert atmosphere. Similarly, in embodiments where a reagent is supplied as a gas, an inert gaseous diluent can be used in the gas stream. In such embodiments, the inert atmosphere or inert gaseous diluent typically is an inert gas, meaning that the gas does not interact with the metathesis catalyst to impede catalysis to a substantial degree. For example, non-limiting examples of inert gases include helium, neon, argon, and nitrogen, used individually or in with each other and other inert gases.

The rector design for the metathesis reaction can vary depending on a variety of factors, including, but not limited to, the scale of the reaction, the reaction conditions (heat, pressure, etc.), the identity of the catalyst, the identity of the materials being reacted in the reactor, and the nature of the feedstock being employed. Suitable reactors can be designed by those of skill in the art, depending on the relevant factors, and incorporated into a refining process such, such as those disclosed herein.

The metathesis reactions disclosed herein generally occur in the presence of one or more metathesis catalysts. Such methods can employ any suitable metathesis catalyst. The metathesis catalyst in this reaction may include any catalyst or catalyst system that catalyzes a metathesis reaction. Any known metathesis catalyst may be used, alone or in combination with one or more additional catalysts. Examples of metathesis catalysts and process conditions are described in US 2011/0160472, incorporated by reference herein in its entirety, except that in the event of any inconsistent disclosure or definition from the present specification, the disclosure or definition herein shall be deemed to prevail. A number of the metathesis catalysts described in US 2011/0160472 are presently available from Materia, Inc. (Pasadena, Calif.).

In some embodiments, the metathesis catalyst includes a Grubbs-type olefin metathesis catalyst and/or an entity derived therefrom. In some embodiments, the metathesis catalyst includes a first-generation Grubbs-type olefin metathesis catalyst and/or an entity derived therefrom. In some embodiments, the metathesis catalyst includes a second-generation Grubbs-type olefin metathesis catalyst and/or an entity derived therefrom. In some embodiments, the metathesis catalyst includes a first-generation Hoveyda-Grubbs-type olefin metathesis catalyst and/or an entity derived therefrom. In some embodiments, the metathesis catalyst includes a second-generation Hoveyda-Grubbs-type olefin metathesis catalyst and/or an entity derived therefrom. In some embodiments, the metathesis catalyst includes one or a plurality of the ruthenium carbene metathesis catalysts sold by Materia, Inc. of Pasadena, Calif. and/or one or more entities derived from such catalysts. Representative metathesis catalysts from Materia, Inc. for use in accordance with the present teachings include but are not limited to those sold under the following product numbers as well as combinations thereof: product no. C823 (CAS no. 172222-30-9), product no. C848 (CAS no. 246047-72-3), product no. C601 (CAS no. 203714-71-0), product no. C627 (CAS no. 301224-40-8), product no. C571 (CAS no. 927429-61-6), product no. C598 (CAS no. 802912-44-3), product no. C793 (CAS no. 927429-60-5), product no. C801 (CAS no. 194659-03-9), product no. C827 (CAS no. 253688-91-4), product no. C884 (CAS no. 900169-53-1), product no. C833 (CAS no. 1020085-61-3), product no. C859 (CAS no. 832146-68-6), product no. C711 (CAS no. 635679-24-2), product no. C933 (CAS no. 373640-75-6).

In some embodiments, the metathesis catalyst includes a molybdenum and/or tungsten carbene complex and/or an entity derived from such a complex. In some embodiments, the metathesis catalyst includes a Schrock-type olefin metathesis catalyst and/or an entity derived therefrom. In some embodiments, the metathesis catalyst includes a high-oxidation-state alkylidene complex of molybdenum and/or an entity derived therefrom. In some embodiments, the metathesis catalyst includes a high-oxidation-state alkylidene complex of tungsten and/or an entity derived therefrom. In some embodiments, the metathesis catalyst includes molybdenum (VI). In some embodiments, the metathesis catalyst includes tungsten (VI). In some embodiments, the metathesis catalyst includes a molybdenum- and/or a tungsten-containing alkylidene complex of a type described in one or more of (a) Angew. Chem. Int. Ed. Engl., 2003, 42, 4592-4633; (b) Chem. Rev., 2002, 102, 145-179; and/or (c) Chem. Rev., 2009, 109, 3211-3226, each of which is incorporated by reference herein in its entirety, except that in the event of any inconsistent disclosure or definition from the present specification, the disclosure or definition herein shall be deemed to prevail.

In certain embodiments, the metathesis catalyst is dissolved in a solvent prior to conducting the metathesis reaction. In certain such embodiments, the solvent chosen may be selected to be substantially inert with respect to the metathesis catalyst. For example, substantially inert solvents include, without limitation: aromatic hydrocarbons, such as benzene, toluene, xylenes, etc.; halogenated aromatic hydrocarbons, such as chlorobenzene and dichlorobenzene; aliphatic solvents, including pentane, hexane, heptane, cyclohexane, etc.; and chlorinated alkanes, such as dichloromethane, chloroform, dichloroethane, etc. In some embodiments, the solvent comprises toluene.

In other embodiments, the metathesis catalyst is not dissolved in a solvent prior to conducting the metathesis reaction. The catalyst, instead, for example, can be slurried with the natural oil or unsaturated ester, where the natural oil or unsaturated ester is in a liquid state. Under these conditions, it is possible to eliminate the solvent (e.g., toluene) from the process and eliminate downstream olefin losses when separating the solvent. In other embodiments, the metathesis catalyst may be added in solid state form (and not slurried) to the natural oil or unsaturated ester (e.g., as an auger feed).

The metathesis reaction temperature may, in some instances, be a rate-controlling variable where the temperature is selected to provide a desired product at an acceptable rate. In certain embodiments, the metathesis reaction temperature is greater than −40° C., or greater than −20° C., or greater than 0° C., or greater than 10° C. In certain embodiments, the metathesis reaction temperature is less than 200° C., or less than 150° C., or less than 120° C. In some embodiments, the metathesis reaction temperature is between 0° C. and 150° C., or is between 10° C. and 120° C.

The metathesis reaction can be run under any desired pressure. In some instances, it may be desirable to maintain a total pressure that is high enough to keep the cross-metathesis reagent in solution. Therefore, as the molecular weight of the cross-metathesis reagent increases, the lower pressure range typically decreases since the boiling point of the cross-metathesis reagent increases. The total pressure may be selected to be greater than 0.1 atm (10 kPa), or greater than 0.3 atm (30 kPa), or greater than 1 atm (100 kPa). In some embodiments, the reaction pressure is no more than about 70 atm (7000 kPa), or no more than about 30 atm (3000 kPa). In some embodiments, the pressure for the metathesis reaction ranges from about 1 atm (100 kPa) to about 30 atm (3000 kPa).

### Optional Hydrogenation

In some embodiments, the metathesis oligomers have two or more carbon-carbon double bonds, and one or more of those carbon-carbon double bonds is removed by hydrogenation. In some embodiments, however, the metathesis oligomers are used directly without an intervening hydrogenation treatment. Hydrogenation may be conducted according to any known method for hydrogenating double bond-containing compounds such as vegetable oils. In some embodiments, the unsaturated polyol ester or metathesized unsaturated polyol ester is hydrogenated in the presence of a nickel catalyst that has been chemically reduced with hydrogen to an active state. Commercial examples of supported nickel hydrogenation catalysts include those available under the trade designations NYSOFACT, NYSOSEL, and NI 5248 D (Englehard Corporation, Iselin, N.H.). Additional supported nickel hydrogenation catalysts include those commercially available under the trade designations PRICAT 9910, PRICAT 9920, PRICAT 9908, PRICAT 9936 (Johnson Matthey Catalysts, Ward Hill, Mass.). In some embodiments, the hydrogenation catalyst comprising, for example, nickel, copper, palladium, platinum, molybdenum, iron, ruthenium, osmium, rhodium, or iridium. Combinations of metals may also be used. Useful catalyst may be heterogeneous or homogeneous. In some embodiments, the catalysts are supported nickel or sponge nickel type catalysts. In some embodiments, the hydrogenation catalyst comprises nickel that has been chemically reduced with hydrogen to an active state (i.e., reduced nickel) provided on a support. In some embodiments, the support comprises porous silica (e.g., kieselguhr, infusorial, diatomaceous, or siliceous earth) or alumina. The catalysts are characterized by a high nickel surface area per gram of nickel.

### Polyol Formation

The methods disclosed herein include reacting at least one of the one or more carbon-carbon double bonds in the metathesis oligomers to form a polyol. Any suitable technique can be used to chemically convert the carbon-carbon double bonds in the metathesis oligomers to saturated hydroxyl-substituted moieties. Suitable methods include, but are not limited to, the methods disclosed herein in the Examples. Other examples include the methods disclosed in U.S. Patent Application Publication Nos. 2015/0299099 and 2015/0307811, which are incorporated herein by reference.

Polyurethane Foams from Self-Metathesized Natural Oil Polyols

In one aspect, the disclosure provides methods of forming a polyurethane compositions, comprising: providing (a) a polyol made by the methods of any of the foregoing aspects and embodiments, and (b) an organic diisocyanate; and reacting the polyol and the organic diisocyanate to form a polyurethane composition.

### Polyurethane Foam Polymerization

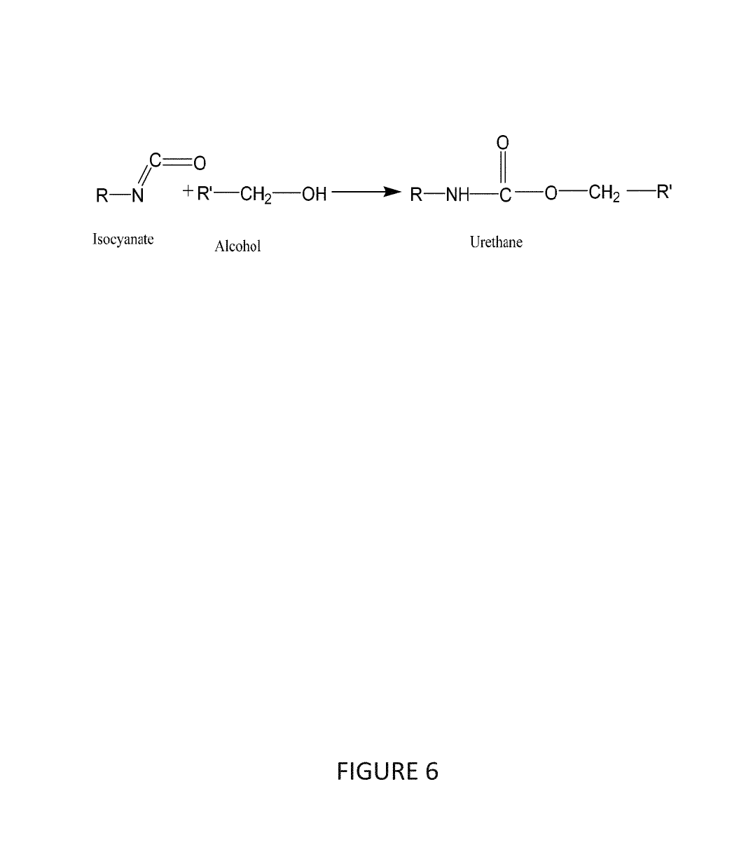

Polyurethanes are one of the most versatile polymeric materials with regards to both processing methods and mechanical properties. The proper selection of reactants enables a wide range of polyurethanes (PU) elastomers, sheets, foams etc. Polyurethane foams are cross linked structures usually prepared based on a polymerization addition reaction between organic isocyanates and polyols, as generally shown in the scheme shown in FIG. 6. Such a reaction may also be commonly referred to as a gelation reaction.

A polyurethane is a polymer composed of a chain of organic units joined by the carbamate or urethane link. Polyurethane polymers are usually formed by reacting one or more monomers having at least two isocyanate functional groups with at least one other monomer having at least two isocyanate-reactive groups, e.g., functional groups which are reactive towards the isocyanate function. The isocyanate (NCO) functional group is highly reactive and is able to react with many other chemical functional groups. In order for a functional group to be reactive to an isocyanate functional group, the group typically has at least one hydrogen atom which is reactive to an isocyanate functional group.

In addition to organic isocyanates and polyols, foam formulations often include one or more of the following non-limiting components: cross-linking components, blowing agents, cell stabilizer components, and catalysts. In some embodiments, the polyurethane foam may be a flexible foam or a rigid foam.

Organic Isocyanates

The polyurethane foams of the present disclosure are, in certain embodiments, derived from an organic isocyanate compound. In order to form large linear polyurethane chains, di-functional or polyfunctional isocyanates are utilized. Suitable polyisocyanates are commercially available from companies such as, but not limited to, Sigma Aldrich Chemical Company, Bayer Materials Science, BASF Corporation, The Dow Chemical Company, and Huntsman Chemical Company. The polyisocyanates of the present disclosure generally have a formula R(NCO)ₙ, where n is between 1 to 10, and wherein R is between 2 and 40 carbon atoms, and wherein R contains at least one aliphatic, cyclic, alicyclic, aromatic, branched, aliphatic- and alicyclic-substituted aromatic, aromatic-substituted aliphatic and alicyclic group. Examples of polyisocyanates include, but are not limited to, diphenylmethane-4,4′-diisocyanate (MDI), which may either be crude or distilled; toluene-2,4-diisocyanate (TDI); toluene-2,6-diisocyanate (TDI); methylene bis (4-cyclohexylisocyanate (H₁₂MDI); 3-isocyanatomethyl-3,5,5-trimethyl-cyclohexyl isocyanate (IPDI); 1,6-hexane diisocyanate (HDI); naphthalene-1,5-diisocyanate (NDI); 1,3- and 1,4-phenylenediisocyanate; triphenylmethane-4,4′,4″-triisocyanate; polyphenyl polymethylene polyisocyanate (PMDI); m-xylene diisocyanate (XDI); 1,4-cyclohexyl diisocyanate (CHDI); isophorone diisocyanate; isomers and mixtures or combinations thereof.

Polyols

The polyols used in the foams disclosed in certain embodiments herein are metathesized triacylglycerol (MSBO) based polyols derived from natural oils, including soybean oil. The synthesis of the MSBO Polyol was described earlier, and involves epoxidation and subsequent hydroxylation of a MSBO derived from soybean oil.

Cross-Linking Components and Chain Extenders

Cross-linking components or chain extenders may be used if needed in preparation of polyurethane foams. Suitable cross-linking components include, but are not limited to, low-molecular weight compounds containing at least two moieties selected from hydroxyl groups, primary amino groups, secondary amino groups, and other active hydrogen-containing groups which are reactive with an isocyanate group. Crosslinking agents include, for example, polyhydric alcohols (especially trihydric alcohols, such as glycerol and trimethylolpropane), polyamines, and combinations thereof. Non-limiting examples of polyamine crosslinking agents include diethyltoluenediamine, chlorodiaminobenzene, diethanolamine, diisopropanolamine, triethanolamine, tripropanolamine, 1,6-hexanediamine, and combinations thereof. Typical diamine crosslinking agents comprise twelve carbon atoms or fewer, more commonly seven or fewer. Other cross-linking agents include various tetrols, such as erythritol and pentaerythritol, pentols, hexols, such as dipentaerythritol and sorbitol, as well as alkyl glucosides, carbohydrates, polyhydroxy fatty acid esters such as castor oil and polyoxy alkylated derivatives of poly-functional compounds having three or more reactive hydrogen atoms, such as, for example, the reaction product of trimethylolpropane, glycerol, 1,2,6-hexanetriol, sorbitol and other polyols with ethylene oxide, propylene oxide, or other alkylene epoxides or mixtures thereof, e.g., mixtures of ethylene and propylene oxides.

Non-limiting examples of chain extenders include, but are not limited to, compounds having hydroxyl or amino functional group, such as glycols, amines, diols, and water. Specific non-limiting examples of chain extenders include ethylene glycol, diethylene glycol, propylene glycol, dipropylene glycol, 1,4-butanediol, 1,3-butanediol, 1,5-pentanediol, neopentyl glycol, 1,6-hexanediol, 1,10-decanediol, 1,12-dodecanediol, ethoxylated hydroquinone, 1,4-cyclohexanediol, N-methylethanolamine, N-methylisopropanolamine, 4-aminocyclohexanol, 1,2-diaminoethane, 2,4-toluenediamine, or any mixture thereof.

Catalyst

The catalyst component can affect the reaction rate and can exert influence on the open celled structures and the physical properties of the foam. The proper selection of a catalyst (or catalysts) appropriately balance the competing interests of the blowing and polymerization reactions. In some embodiments, a correct balance may be needed due to the possibility of foam collapse if the blow reaction proceeds relatively fast. On the other hand, if the gelation reaction overtakes the blow reaction, foams with closed cells might result and this might lead to foam shrinkage or ‘pruning’. Catalyzing a polyurethane foam, therefore, involves choosing a catalyst package in such a way that the gas produced becomes sufficiently entrapped in the polymer. The reacting polymer, in turn, must have sufficient strength throughout the foaming process to maintain its structural integrity without collapse, shrinkage, or splitting.

The catalyst component is selected from the group consisting of tertiary amines, organometallic derivatives or salts of, bismuth, tin, iron, antimony, cobalt, thorium, aluminum, zinc, nickel, cerium, molybdenum, vanadium, copper, manganese and zirconium, metal hydroxides and metal carboxylates. Tertiary amines may include, but are not limited to, triethylamine, triethylenediamine, N,N,N′,N′-tetramethylethylenediamine, N,N,N′,N′-tetraethylethylenediamine, N-methylmorpholine, N-ethylmorpholine, N,N,N′,N′-tetramethylguanidine, N,N,N′,N′-tetramethyl-1,3-butanediamine, N,N-dimethylethanolamine, N,N-diethylethanolamine. Suitable organometallic derivatives include di-n-butyl tin bis(mercaptoacetic acid isooctyl ester), dimethyl tin dilaurate, dibutyl tin dilaurate, dibutyl tin sulfide, stannous octoate, lead octoate, and ferric acetylacetonate. Metal hydroxides may include sodium hydroxide and metal carboxylates may include potassium acetate, sodium acetate or potassium 2-ethylhexanoate.

Blowing Agents

Polyurethane foam production may be aided by the inclusion of a blowing agent to produce voids in the polyurethane matrix during polymerization. The blowing agent promotes the release of a blowing gas which forms cell voids in the polyurethane foam. The blowing agent may be a physical blowing agent or a chemical blowing agent. The physical blowing agent can be a gas or liquid, and does not chemically react with the polyisocyanate composition. The liquid physical blowing agent typically evaporates into a gas when heated, and typically returns to a liquid when cooled. The physical blowing agent typically reduces the thermal conductivity of the polyurethane foam. Suitable physical blowing agents for the purposes of the invention may include liquid carbon dioxide, acetone, and combinations thereof. The most typical physical blowing agents typically have a zero ozone depletion potential. Chemical blowing agents refers to blowing agents which chemically react with the polyisocyanate composition.

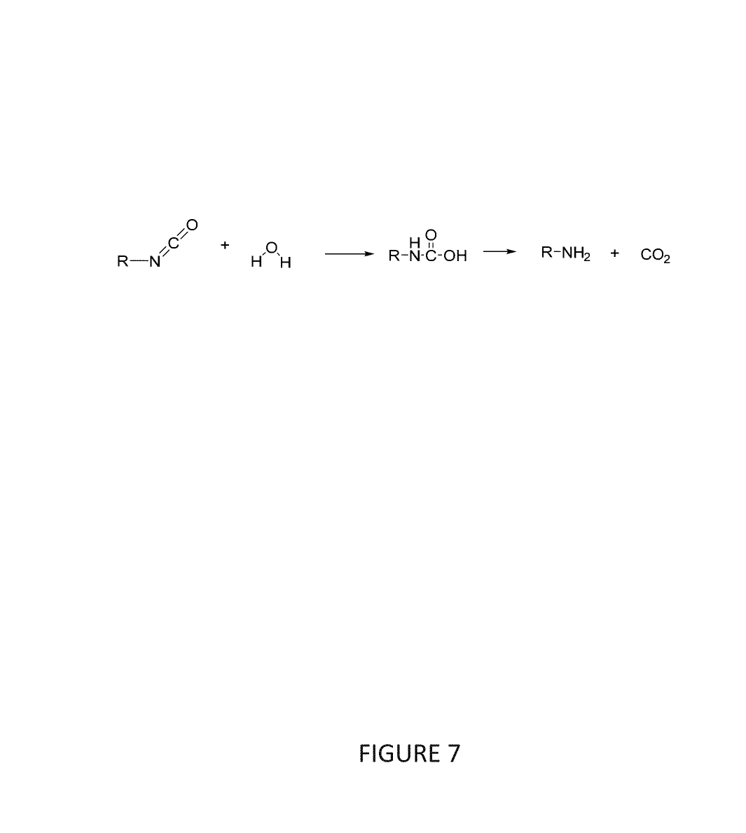

Suitable blowing agents may also include compounds with low boiling points which are vaporized during the exothermic polymerization reaction. Such blowing agents are generally inert or they have low reactivity and therefore it is likely that they will not decompose or react during the polymerization reaction. Examples of blowing agents include, but are not limited to, water, carbon dioxide, nitrogen gas, acetone, and low-boiling hydrocarbons such as cyclopentane, isopentane, n-pentane, and their mixtures. Previously, blowing agents such as chlorofluorocarbons (CFCs), hydrofluorocarbons (HFCs), hydrochlorofluorocarbons (HCFCs), fluoroolefins (FOs), chlorofluoroolefins (CFOs), hydrofluoroolefins (HFOs), and hydrochlorfluoroolefins (HCFOs), were used, though such agents are not as environmentally friendly. Other suitable blowing agents include water that reacts with isocyanate to produce a gas, carbamic acid, and amine, as shown in the reaction scheme depicted in FIG. 7

Cell Stabilizers

Cell stabilizers may include, for example, silicone surfactants or anionic surfactants. Examples of suitable silicone surfactants include, but are not limited to, polyalkylsiloxanes, polyoxyalkylene polyol-modified dimethylpolysiloxanes, alkylene glycol-modified dimethylpolysiloxanes, or any combination thereof. Suitable anionic surfactants include, but are not limited to, salts of fatty acids, salts of sulfuric acid esters, salts of phosphoric acid esters, salts of sulfonic acids, and combinations of any of these. Such surfactants provide a variety of functions, reducing surface tension, emulsifying incompatible ingredients, promoting bubble nucleation during mixing, stabilization of the cell walls during foam expansion, and reducing the defoaming effect of any solids added. Of these functions, a key function is the stabilization of the cell walls, without which the foam would behave like a viscous boiling liquid.

Additional Additives

If desired, the polyurethane foams can have incorporated, at an appropriate stage of preparation, additives such as pigments, fillers, lubricants, antioxidants, fire retardants, mold release agents, synthetic rubbers and the like which are commonly used in conjunction with polyurethane foams.

### Flexible Foam Embodiments

In some embodiments, the polyurethane foam may be a flexible foam, where such composition comprises (i) at least one polyol composition derived from a natural oil based metathesized triacylglycerols component; (ii) at least one polyisocyanate component, wherein the ratio of hydroxy groups in said at least one polyol to isocyanate groups in said at least one polyisocyanate component is less than 1; (iii) at least one blowing agent; (iv) at least one cell stabilizer component; and (v) at least one catalyst component; wherein the composition has a wide density range, which can be between about 85 kgm⁻³ and 260 kgm⁻³, but can in some instances be much wider.

### EXAMPLES

The following examples are provided to illustrate one or more preferred embodiments of the invention. Numerous variations can be made to the following examples that lie within the scope of the claimed inventions.

### Synthesis and Properties of MSBO Polyols

### Analytical Methods for MSBO Polyol

The MSBO polyols were analyzed using different techniques. These techniques can be broken down into: (i) chemistry characterization techniques, including OH value, acid value, nuclear magnetic resonance (NMR); and (ii) physical characterization methods, including thermogravimetric analysis (TGA), differential scanning calorimetry (DSC), and rheology.

Chemistry Characterization Techniques for MSBO Polyol

OH and acid values of the MSBO Polyol were determined according to ASTM D1957-86 and ASTM D4662-03, respectively.

¹H-NMR spectra were recorded in CDCl₃ on a Varian Unity-INOVA at 499.695 MHz. ¹H chemical shifts are internally referenced to CDCl₃ (7.26 ppm). All spectra were obtained using an 8.6-μs pulse with 4 transients collected in 16,202 points. Datasets were zero-filled to 64,000 points, and a line broadening of 0.4 Hz was applied prior to Fourier transformation. The spectra were processed using ACD Labs NMR Processor, version 12.01.

Physical Characterization Techniques for MSBO Polyol

TGA was carried out on a TGA Q500 (TA Instruments, DE, USA) equipped with a TGA heat exchanger (P/N 953160.901). Approximately 8.0 -15.0 mg of sample was loaded in the open TGA platinum pan. The sample was heated from 25° C. to 600° C. under dry nitrogen at a constant rate of 10° C./min.

DSC measurements of the MSBO Polyol were run on a Q200 model (TA Instruments, New Castle, Del.) under a nitrogen flow of 50 mL/min. MSBO Polyol samples between 3.5 and 6.5 (±0.1) mg were run in standard mode in hermetically sealed aluminum DSC pans. The sample was equilibrated at 90° C. for 10 min to erase thermal memory, then cooled at 5.0° C./min to −90° C. where it was held isothermally for 5 min, and subsequently reheated at 5.0° C./min to 90° C. The “TA Universal Analysis” software was used to analyze the DSC thermograms and extract the peak characteristics. Characteristics of non-resolved peaks were obtained using the first and second derivatives of the differential heat flow.

### Synthesis of MSBO Polyol

MSBO polyol was prepared using a one-pot, two step reaction. Neat MSBO was epoxidized using hydrogen peroxide and formic acid, and then hydroxylated in THF and water using perchloric acid. The amount of hydrogen peroxide and formic acid was varied to control the degree of epoxidation.

100 g MSBO was added into 100 g, 35 g or 24 g formic acid (88%) in a 1000 mL three neck flask with mechanical stirring at room temperature and then 140 g, 40 g or 30 g hydrogen peroxide (30%), respectively, was slowly added to the reactor (addition rate: ˜1 L/h) with or without external cooling. The reaction at room temperature was continued for 5 h, and then 150 mL THF in 100 mL water followed by 8 g HClO₄ (70%) was added to the reactor. The reaction mixture was stirred at room temperature for 30 h. The stirring was then halted and 100 mL ethyl acetate added to the still reaction. The organic layer was separated from the water layer. The organic layer was washed with 100 mL water, 100 mL 5% NaHCO₃ and 2×100 mL water sequentially, and then dried on a rotary evaporator.

The achieved polyols are listed in Table 2. The samples are labeled based on whether or not cooling was provided (W=with water cooling and WO=without water cooling) and on the amount of H₂O₂ used in the reaction. PWO-140, PWO-45, PWO-30 are codes for the polyols prepared without water cooling and with 140 g, 45 g and 30 g of H₂O₂, respectively, and PW-140,PW-45, PW-30 are codes for the polyols prepared with water cooling and with 140 g, 45 g and 30 g of H₂O₂, respectively.

¹H-NMR of the MSBO Polyols

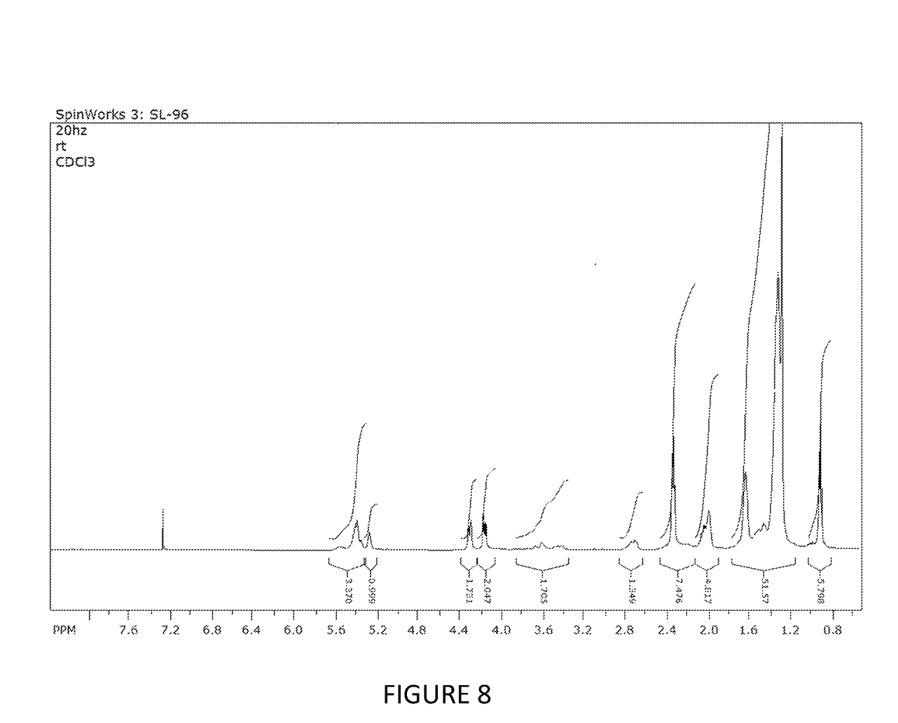

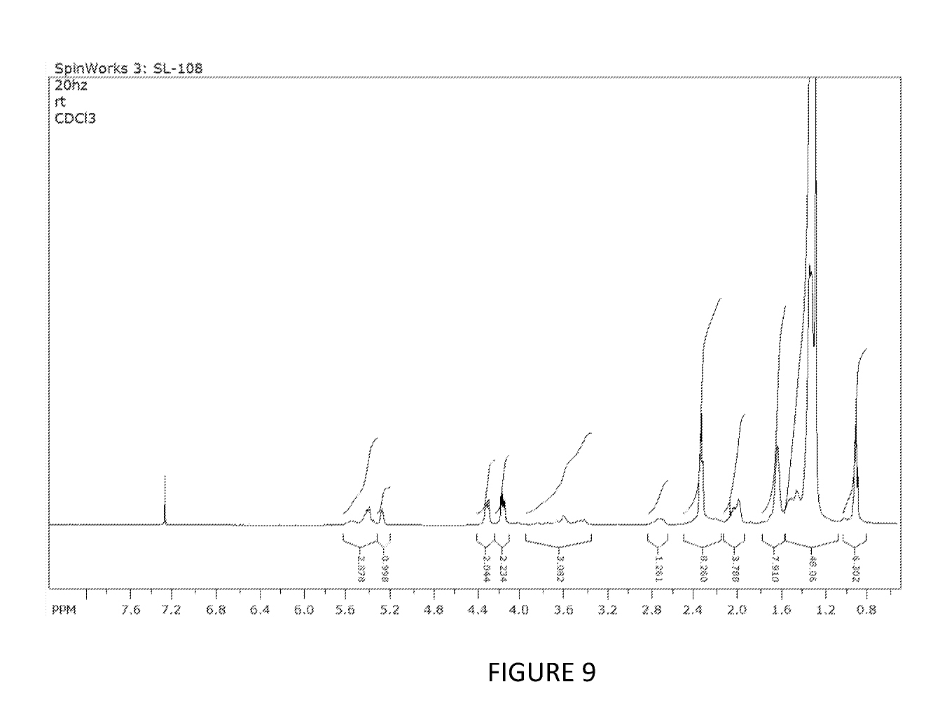

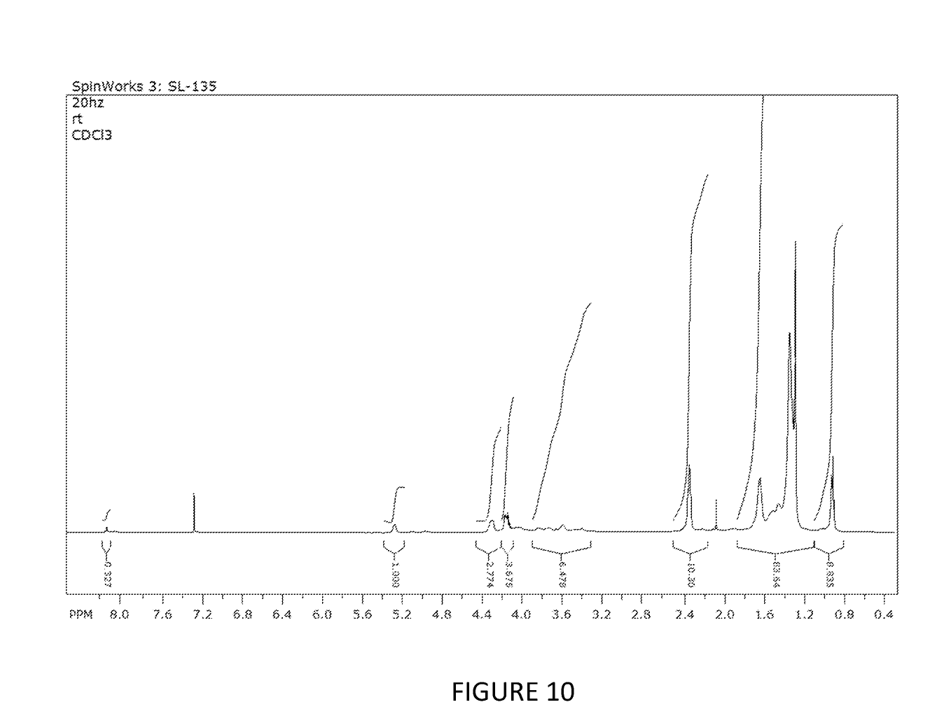

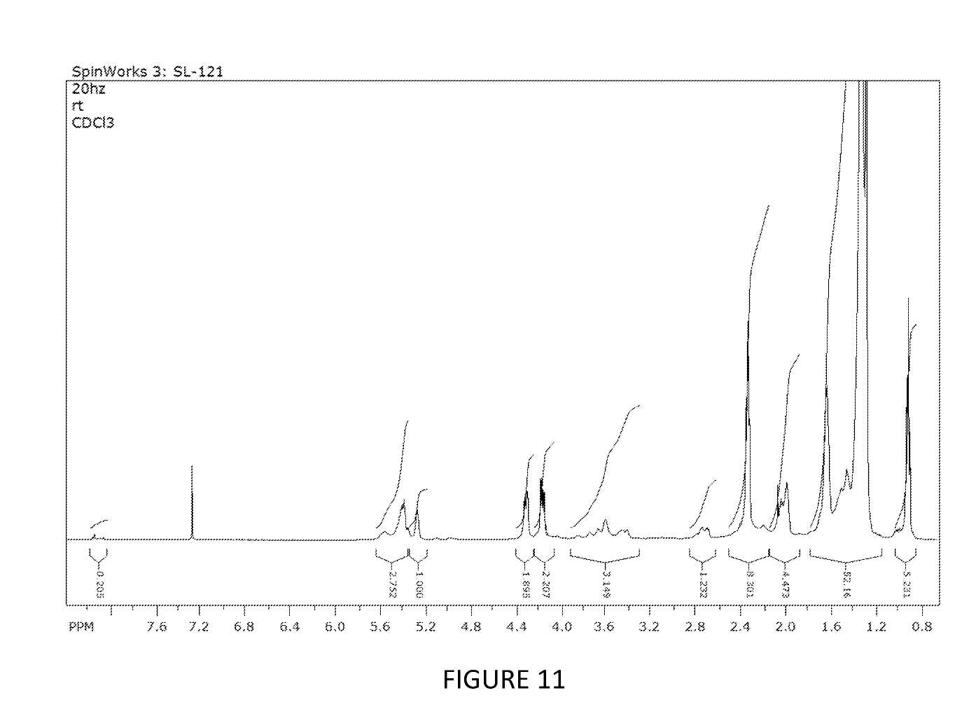

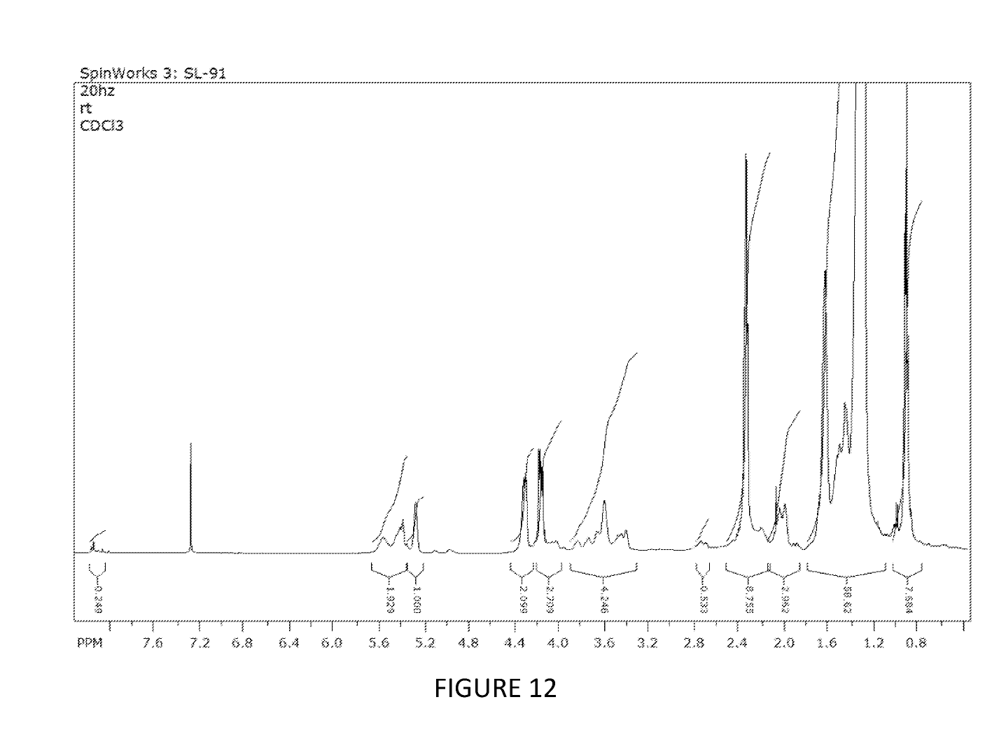

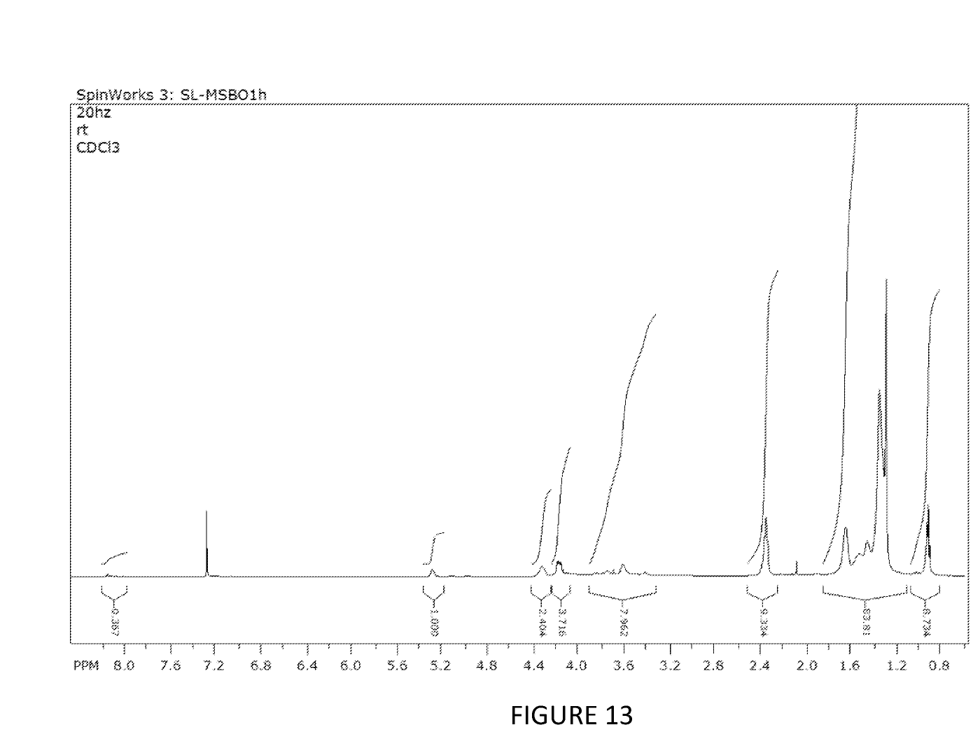

The ¹H-NMIR spectra of MSBO Polyols are shown in FIGS. 8-13 for the following MSBO polyols: PW-30, PW-45, PW-140, PWO-30, PWO-45, and PWO-140, respectively.

The protons of the glycerol skeleton, —CH₂CH(O)CH₂— and —OCH₂CHCH₂O— are presented at δ 5.3-5.2 ppm and 4.4-4.1 ppm, respectively; —C(═O)CH₂— at δ 2.33-2.28 ppm; α-H to —CH═CH— at δ 2.03-1.98 ppm; —C(═O)CH₂CH₂— at δ 1.60 ppm, and —CH₃ at 0.9-0.8 ppm. The chemical shift of the double bonds are presented at ˜5.4 ppm. The chemical shift at ˜8.2 ppm found in the polyols prepared without using a cooling bath (PWOs, i.e., PWO-30, 45 and 140) and the polyol prepared with 140 g of H₂O₂ using a cooling bath (PW-140) is related to formic acid units attached on the fatty acid. The chemical shifts at 3.8-3.4 ppm related to the protons neighboured by —OH appeared, and the chemical shifts at ˜2.8 ppm related to the epoxide ring disappeared, indicating that the hydroxylation of epoxy rings was complete. The number of remaining double bonds per TAG structure were calculated based on the peak area ratio of the chemical shift at ˜5.4 ppm and at 5.3-5.2 ppm, and that of formic acid units attached per TAG structure based on the peak area ratio of the chemical shift at ˜8.2 ppm and at 5.3-5.2 ppm.

The polyols prepared without using a cooling bath (PWO Polyols) presented a higher OH value compared to the polyols made under a cooling bath (PW Polyols) because of self-heating during the preparation of the PWOs. Also, there are formic acid attached on the fatty acid chain. The hydroxyl value (OH value) and acid value of the MSBO Polyols are provided in Table 2. There were no free fatty acids detected by ¹H-NMR. There was also no signal that can be associated with the loss of free fatty acids in the TGA of the MSBO Polyols. The acid value reported in Table 2 was probably due to the hydrolysis of the polyols during the actual titration, which uses strong base as the titrant, with the result that the actual titration causes hydrolysis.

TABLE 2
Characterization data of MSBO Polyols.

| | | | | Acid | | |
|---|---|---|---|---|---|---|
| MSBO Polyols | | Code | OH value | Value | AFA | RDB |
| Without water | PWO-140 | SL-28 | 263 | 12 | 0.24 | 0 |
| cooling | (1 h) | | | | | |
| | PWO-45 | SL-91 | 233 | 5 | 0.17 | 1.27 |
| | PWO-30 | SL-121 | 169 | 5 | 0.32 | 1.78 |
| With water | PW-140 | SL-135 | 203 | 11 | 0.24 | 0 |
| cooling | PW-45 | SL-108 | 156 | 2.5 | 0 | 1.15 |
| | PW-30 | SL-96 | 98.7 | 4 | 0 | 1.91 |

OH-value and Acid value (mg/100 g).
RDB: number of remaining double bonds per TAG structure;
AFA: number of attached formic acid per TAG structure.

Physical properties of MSBO Polyols

Thermal Transition Behavior of MSBO Polyols

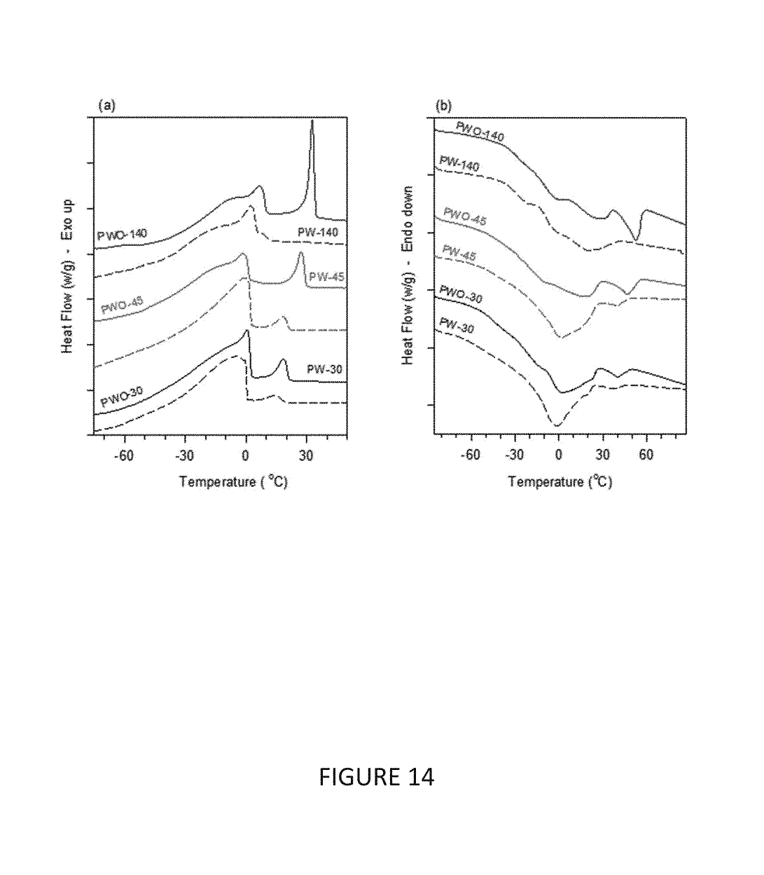

The DSC cooling and heating profiles (both at 5° C./min) of MSBO Polyols are shown in FIGS. 14a and b, respectively. Two main exotherms, which can be related to high and low melting fractions were observed for MSBO Polyols. The heating thermograms of the polyols displayed two main endothermic events but no exotherms, suggesting that polymorphic transformation mediated by melt did not occur. The detailed characteristic temperature data are provided in Table 3.

TABLE 3
Characteristic temperatures of melting and crystallization of MSBO Polyols: Tₒₙ^{c}: onset
temperature of crystallization; T_{off}^{m}: offset temperature of melting; T_{g}: glass transition
temperature determined from the heating cycle. ΔH_{c} and ΔHₘ are enthalpy of crystallization
and melting, respectively.

| MSBO polyols | | Code | Tₒₙ^{c} (° C.) | T_{off}^{m} (° C.) | T_{g} (° C.) | ΔH_{c} (J/g) | ΔHₘ (J/g) |
|---|---|---|---|---|---|---|---|
| Without | PWO-140 (1 h) | | 34.86 | 56.92 | −9.29 | 15.6 | 14.1 |
| water cooling | PWO-45 | SL-91 | 29.89 | 55.04 | −27.64 | 20.6 | 18.6 |
| | PWO-30 | SL-121 | 21.20 | 48.87 | −22.24 | 23.3 | 13.2 |
| With water | PW-140 | SL-135 | 11.85 | 41.15 | −30.39 & | 13.8 | 4.2 |
| cooling | | | | | −8.59 | | |
| | PW-45 | SL-108 | 21.46 | 49.1 | Not clear | 24.1 | 21.4 |
| | PW-30 | SL-96 | 19.16 | 43.3 | Not clear | 27.1 | 26.3 |

Thermal Gravimetric Analysis of MSBO Polyols

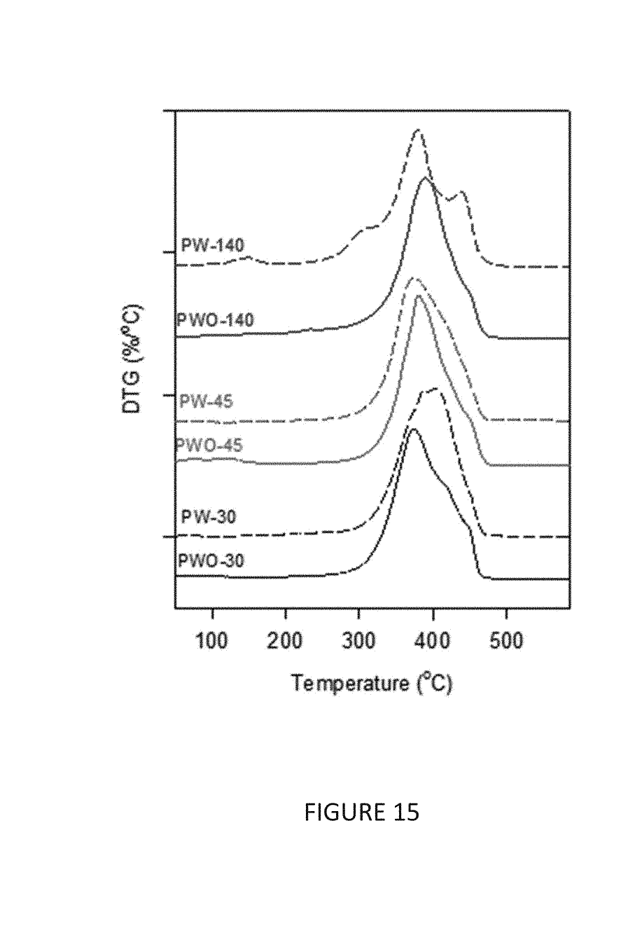

The DTG profiles of the MSBO polyols are shown in the FIG. 15. The onset temperature of degradation values as measured at 5% and 10% decomposition, and the DTG peak temperatures are provided in Table 4.

DTG curves of the MSBO polyols revealed a decomposition spanning from ˜170° C. and ending at 470° C. As can be seen from the DTG curves of FIG. 3, MSBO polyols presented three main steps of degradation. The first step (before 250° C.) which involved ˜5% weight loss in PWO-140 and PW-140, is associated with the degradation of the free fatty acids present in the material. The second degradation process, recognizable by large DTG peaks at 350° C. and 440° C., involved more than 70% weight loss and is associated with degradation of ester linkage. The final step which is detected by a DTG shoulder at ˜440-490° C. is associated with clearance of carbon-carbon bonds.

TABLE 4
TGA data of MSBO Polyols.

| | | | | | | Decomposition steps | | | | | |
|---|---|---|---|---|---|---|---|---|---|---|---|
| | | | | | | I | | II | | III | |
| Sample | T_{5%} | T_{10%} | T_{D1} | T_{D2} | T_{D3} | TR | WL | TR | WL | TR | WL |
| PWO-140 | 264 | 310 | | 390 | | 172-268 | 4.6 | 268-444 | 87 | 444-483 | 5 |
| PW-140 | 219 | 289 | 304 | 380 | | 213-320 | 13 | 320-421 | 61 | 421-493 | 18 |
| PWO-45 | 313 | 340 | | 379 | | 253-443 | 93 | 443-480 | 7 | | |
| PW-45 | 230 | 330 | | 373 | | 193-417 | 77 | 418-441 | 13 | 441-481 | 6 |
| PWO-30 | 302 | 332 | | 373 | | 255-413 | 73 | 413-446 | 17 | 446-475 | 4 |
| PW-30 | 311 | 342 | | 383 | | 227-416 | 71 | 416-443 | 18 | 443-490 | 7 |

TR: temperature range (° C.);
WL: weight loss (%);
I-III: degradation step I-III;
T_{D1-3}: peak temperature (° C.) of DTG curve at step I-III;
T_{5%} and T_{10%}: temperature (° C.) determined at 5% and 10% weight loss, respectively.

### Analytical Methods for MSBO Polyol Foam Analysis

The MSBO polyol foam was analyzed using different techniques. These techniques can be broken down into: (i) chemistry characterization techniques, including NCO value and Fourier Transform infrared spectroscopy (FTIR); and (ii) physical characterization methods, including thermogravimetric analysis (TGA), differential scanning calorimetry (DSC), scanning electron microscopy (SEM) and compressive test.

Chemistry Characterization Techniques of MSBO Polyol Foam

The amount of reactive NCO (% NCO) for the crude diisocyanates was determined by titration with dibutylamine (DBA). MDI (2±0.3 g) was weighed into 250 ml conical flasks. 2N DBA solution (20 ml) was pipetted to dissolve MDI. The mixture is allowed to boil at 150° C. until the vapor condensate is at an inch above the fluid line. The flasks were cooled to room temperature (RT) and rinsed with methanol to collect all the products. 1 ml of 0.04% bromophenol blue indicator is then added and titrated against 1N HCl until the color changes from blue to yellow. A blank titration using DBA was also done.

The equivalent weight (E w) of the MDI is given by Eq. 1

$$EW = \frac{W \times 1000}{( {V}_{1} - {V}_{2} ) \times N} \qquad Eq . 1$$

where W is the weight of MDI in g, V₁ and V₂ are the volume of HCl for the blank and MDI samples, respectively. N is the concentration of HCl The NCO content (%) is given by Eq. 2:

$$\% NCO content = \frac{42}{EW} \times 100 \qquad Eq . 2$$

FTIR spectra were obtained using a Thermo Scientific Nicolet 380 FT-IR spectrometer (Thermo Electron Scientific Instruments, LLC, USA) equipped with a PIKE MIRacle™ attenuated total reflectance (ATR) system (PIKE Technologies, Madison, Wis., USA.). Foam samples were loaded onto the ATR crystal area and held in place by a pressure arm. The spectra were acquired over a scanning range of 400-4000 cm⁻¹ for 32 repeated scans at a spectral resolution of 4 cm⁻¹.

Physical Characterization Techniques of MSBO Polyol Foam

TGA was carried out on a TGA Q500 (TA Instruments, DE, USA) equipped with a TGA heat exchanger (P/N 953160.901). Approximately 8.0-15.0 mg of sample was loaded in the open TGA platinum pan. The sample was heated from 25 to 600° C. under dry nitrogen at a constant rate of 10° C./min.

DSC measurements were run on a Q200 model (TA Instruments, New Castle, Del.) under a nitrogen flow of 50 mL/min. MSBO Polyol Foam samples between 3.0 and 6.0 (±0.1) mg were run in hermetically sealed aluminum DSC pans. In order to obtain a better resolution of the glass transition, MSBO Polyol foams were investigated using modulated DSC following ASTM E1356-03 standard. The sample was first equilibrated at −90° C. and heated to 150° C. at a constant rate of 5.0° C./min (first heating cycle), held at 150° C. for 1 min and then cooled down to −90° C. with a cooling rate of 5° C./min, and subsequently reheated to 150° C. at the same rate (second heating cycle). Modulation amplitude and period were 1° C. and 60 s, respectively. The “TA Universal Analysis” software was used to analyze the DSC thermograms.

The compressive strength of the foams was measured at room temperature using a texture analyzer (Texture Technologies Corp, NJ, USA). Samples were prepared in cylindrical Teflon molds of 60-mm diameter and 36-mm long. The cross head speed was 3.54 mm/min with a load cell of 500 kgf. The load for the flexible foams was applied until the foam was compressed to approximately 65% of its original thickness, and compressive strengths were calculated based on 5, 10 and 25% deformation.

Scanning electron microscopy (SEM) images of the foams were acquired on a Phenom ProX (Phenom-World, The Netherlands) apparatus at an accelerating voltage of 15 kV and map intensity. Uncoated foams were cut into thin rectangular segments and fixed to a temperature controlled sample holder with conductive tape. Samples were cooled to −25° C. to prevent beam induced thermal deformations, and composite images were captured using the Automated Image Mapping software (Phenom-World, The Netherlands).

### Polymerization Conditions

General Materials

The materials used to produce the foams are listed in Table 5. The MSBO Polyols were obtained from the MTAG of soybean oil (MSBO) using the epoxidation and hydrogenation synthesis route as generally described above. A commercial isocyanate, methylene diphenyl diisocyanate (MDI) and a general-purpose silicone surfactant, polyether-modified (TEGOSTAB B-8404, Goldschmidt Chemical Canada) were used in the preparation. The physical properties of the crude MDI as provided by the supplier are reported in Table 5. The foam will be referred simply as MSBO Polyol foam.

TABLE 5
Materials used in the polymerization reaction

| Material | |
|---|---|
| Polyol | MSBO Polyol |
| Isocyanate | Crude MDI^{a} |
| Catalyst | DBTDL^{b}, 95% |
| | DMEA^{c}, 99.5% |
| Cross linker | Glycerin, 99.5% |
| Surfactant | TEGOSTAB ® B-8404^{d} |
| Blowing agent | CO₂ from addition of 2% deionized H₂O |

^{a}MDI: Diphenylmethane diisocynate, from Bayer Materials Science, Pittsburgh, PA
^{b}DBTDL: Dibutin Dilaurate, main catalyst, from Sigma Aldrich, USA
^{c}DMEA: N,N-Dimethylethanolamine, co-catalyst, from Fischer Chemical, USA
^{d}TEGOSTAB ® B-8404, Polyether-modified, a general-purpose silicone surfactant, from Goldschmidt Chemical, Canada

The properties of MDI are provided in Table 6. Table 7 shows the corresponding chemical shift values.

TABLE 6
Properties of crude MDI.

| Property | Value |
|---|---|
| Form | Dark brown liquid |
| Boiling Point (° C.) | 208 |
| NCO content (% wt.) | 31.5 |
| Equivalent weight | 133 |
| Functionality | 2.4 |
| Viscosity at 25° C. (mPas) | 200 |
| Bulk density (kgm⁻³) | 1234 |
| Composition | Polymeric MDI: 40-50% |
| | (4,4′ diphenylmethane diisocyanate): 30-40% |
| | MDI mixed isomers: 15-25% |

TABLE 7
¹H-NMR data of crude MDI.

| | NCO at | | | | | | | |
|---|---|---|---|---|---|---|---|---|
| | position 2 | | | | | | | |
| | of Benzene | NCO at 4 position of | | CH₂ in | | | | |
| | p, o, m | Benzene | | isomers | | | | |
| Proton | (CH═CH) | m(CH═CH) | o(CH═CH) | 2,2′ | 2,4′ | 4,4′ | Others | Oligomers |
| δ | 7.14-7.16 | 7.08-7.12 | 7.02-7.04 | 4.04 | 3.99 | 3.94 | 3.89 | 3.93 |
| (ppm) | | | | | | | | |

Synthesis of Foams from MSBO Polyol

Flexible polyurethane foams were obtained using the recipe formulations shown in Table 8. The amount of each component of the polymerization mixture was based on 100 parts by weight of total polyol. The amount of MDI was based on an isocyanate index of 1.2. All the ingredients, except MDI, were weighed into a beaker. MDI was added to the beaker using a syringe and mechanically mixed vigorously for ˜10 s. At the end of the mixing, the mixture was poured into a cylindrical Teflon mold (60-mm diameter and 35-mm long), which was previously greased with silicone release agent, and sealed with a hand tightened clamp. The sample was cured for four (4) days at 40° C. and post cured for one (1) day at room temperature.

TABLE 8
Formulation Recipe for Flexible Foams.

| Ingredients | Parts |
|---|---|
| MSBO Polyol | 100 |
| OH:NCO ratio | 1:1.2 |
| Glycerin | 0 |
| Water | 2 |
| Surfactant | 2 |
| Catalyst | 0.1 |
| Co-catalyst | 0.1 |
| Mixing Temperature (° C.) | 40 |
| Oven Temperature (° C.) | 40 |

### MSBO Polyol Foam Produced

FTIR of MSBO Polyol Foam

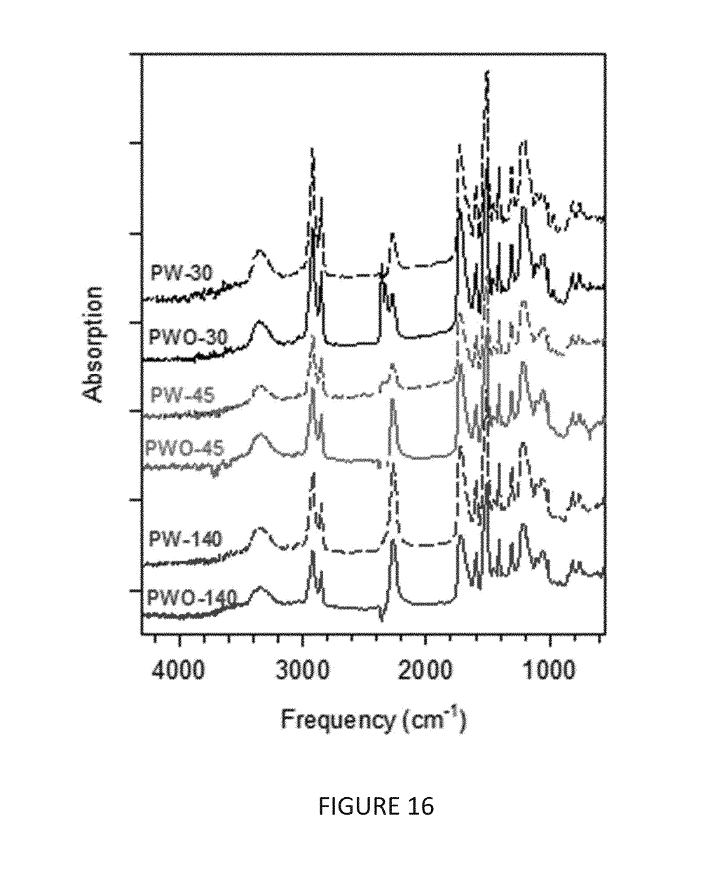

FTIR spectra of MSBO Polyol Foams are shown in FIG. 16. Table 9 lists the characteristic vibrations of the foams. The broad absorption band observed at 3300-3400 cm⁻¹ in the foam is characteristic of NH group associated with the urethane linkage. The weak band at 2270 cm⁻¹ indicates that free NCO are present in the foam. The overlapping peaks between 1710 and 1735 cm⁻¹ suggest the formation of urea, isocyanurate and free urethane in the MSBO Polyol foams. The peak at 971cm⁻¹ which is characteristic of the ═C—H bend, showed in PWO-45, PW-45, PW-30 and PW-30, but not in PWO-140 and PW-140, indicating that the polyurethane foams from PWO-45, PW-45, PWO-30 and PW-30 contain double bonds.

The CH₂ stretching vibration is visible at 2800-3000 cm⁻¹ . The characteristic of C═O band centered at 1700 cm⁻¹ demonstrates the formation of urethane linkages. The band at 1744 cm⁻¹ is attributed to the C═O stretching of the ester groups. The sharp band at 1150-1160 cm⁻¹ and 1108-1110 cm⁻¹ are the O—C—C and C—C(═O)—O stretching bands, respectively, of the ester groups. The band at 1030-1050 cm⁻¹ is due to CH₂ bend.

TABLE 9
FTIR data of MSBO Polyol foam.

| Moiety | Wavelengths (cm⁻¹) |
|---|---|
| H-bonded and free N—H groups | 3300-3400 |
| Free NCO | 2270 |
| Urea | 1717 |
| Isocyanurate | 1710 |
| Free Urethane | 1735 |
| ═C—H | 971 |

### Physical Properties of MSBO Polyol Foams

Thermal Stability of MSBO Polyol Foams

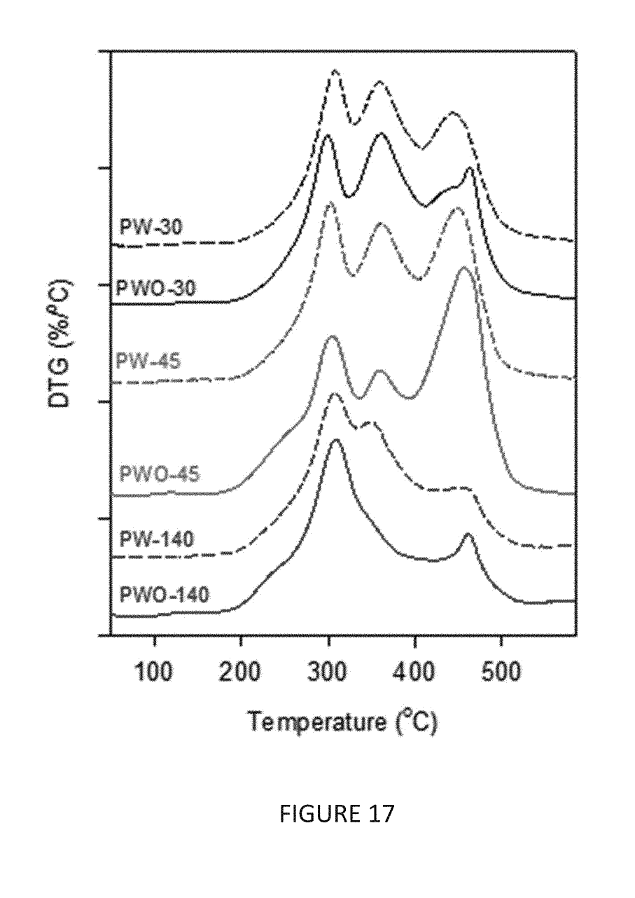

The thermal stability of the MSBO Polyol foams was determined by TGA. Typical DTG curves of flexible MSBO Polyol foams are shown in FIG. 17. Temperature of degradation determined at 1 and 5% weight loss (T_{1%} and T_{5%}, respectively), and DTG peak temperatures (T_{D1-3}) typical of rigid and flexible MSBO Polyol foams are listed in Table 10.

The initial step of decomposition as indicated by the DTG peak at ˜300° C. spanned ˜200-330° C. with a total weight loss of ˜24-30%. It was due to the degradation of urethane linkages, which involves dissociations to the isocyanate and the alcohol, amines and olefins or to secondary amines. The second decomposition step in the range of temperature between 330 and 400° C. and indicated by the DTG peak at 360° C. with a total weight loss of 16-30%, was due to degradation of the ester groups. The degradation steps at higher temperatures were attributed to the degradation of more strongly bonded fragments. Note that a relatively high amount of ash (˜11-35%) was left after the degradation of MSBO polyols.

TABLE 10
Thermal degradation data of MSBO Polyol foams.

| | | | | | | Decomposition steps | | | | | | |
|---|---|---|---|---|---|---|---|---|---|---|---|---|
| PU foam | Temperature at | | | | | I | | II | | III | | |
| Sample | T_{5%} | T_{10%} | T_{D1} | T_{D2} | T_{D3} | TR | WL | TR | WL | TR | WL | Ash |
| PWO-140 | 180 | 243 | 309 | | 463 | 180-400 | 46 | | | 400-530 | 15 | 39 |
| PW-140 | 198 | 254 | 309 | 350 | 460 | 190-332 | 29 | 332-413 | 22 | 413-530 | 6 | 35 |
| PWO-45 | 200 | 248 | 304 | 360 | 457 | 200-335 | 30 | 335-393 | 16 | 393-530 | 43 | 11 |
| PW-45 | 206 | 259 | 302 | 361 | 450 | 205-327 | 27 | 327-404 | 26 | 404-530 | 30 | 18 |
| PWO-30 | 211 | 261 | 299 | 360 | 462 | 211-323 | 24 | 323-410 | 30 | 410-530 | 24 | 22 |
| PW-30 | 206 | 266 | 307 | 358 | 444 | 206-330 | 25 | 330-407 | 27 | 407-530 | 24 | 24 |

TR: temperature range (° C.);
WL: weight loss (%);
I-III: degradation step I-III;
T_{D1-3}: peak temperature (° C.) of DTG curve at step I-III;
T_{5%} and T_{10%}: temperature (° C.) determined at 5% and 10% weight loss, respectively. Ash (%)

Thermal Transition Behavior of MSBO Polyol Foam

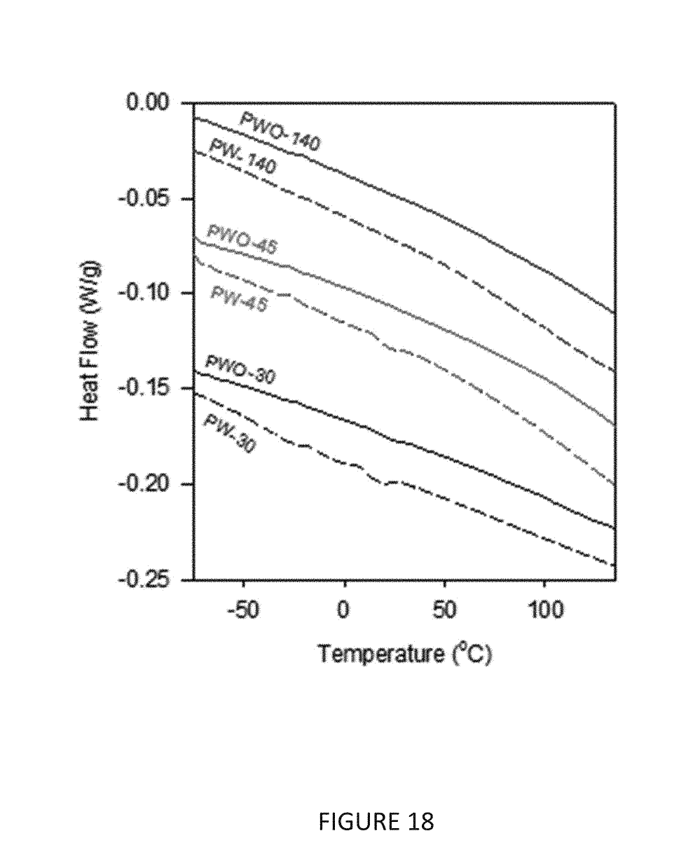

Typical curves obtained from the modulated DSC during the second heating cycle of the flexible MSBO Polyol foams are shown in FIG. 18. No clear glass transition temperature (T_{g}) of the flexible MSBO Polyol foams produced was shown.

Compressive Strength of Flexible MSBO Polyol Foams

Table 11 lists the compressive strength at 10%, 25% and 50% deformation of flexible MSBO Polyol foams.

TABLE 11
Compressive strength value at 10, 25 and 50% deformation of flexible MSBO foams.

| | | | Density | | Stress (MPa) @ | | | Recovery |
|---|---|---|---|---|---|---|---|---|
| MSBO polyols | | Code | Kg/m³ | OH value | 10% | 25% | 50% | after 24 h |
| PWO | PWO-140 (1 h) | | 152 | 263 | 0.69 | 0.66 | 0.76 | Crashed |
| | PWO-45 | SL-91 | 158 | 233 | 0.67 | 0.75 | 0.98 | Crashed |
| | PWO-30 | SL-121 | 161 | 169 | 0.50 | 0.78 | 1.08 | ~85% |
| PW | PW-140 | SL-135 | | 203 | 0.75 | 0.90 | 1.18 | ~74% |
| | PW-45 | SL-108 | 138 | 156 | 0.26 | 0.63 | 0.63 | ~85% |
| | PW-30 | SL-96 | 155 | 98.7 | 0.065 | 0.089 | 0.22 | ~94%^{a} |
| PMTAG | | | 160 | 155 | 0.75 | 1.16 | | ~75% |
| Polyol Foam | | | | | | | | |

^{a}Recovery after 10 min
PMTAG polyol foams data (WO 2015/143568) are provided for comparison purposes.
PWO: Polyol synthesized Without water cooling;
PW: Polyol synthesized With water cooling

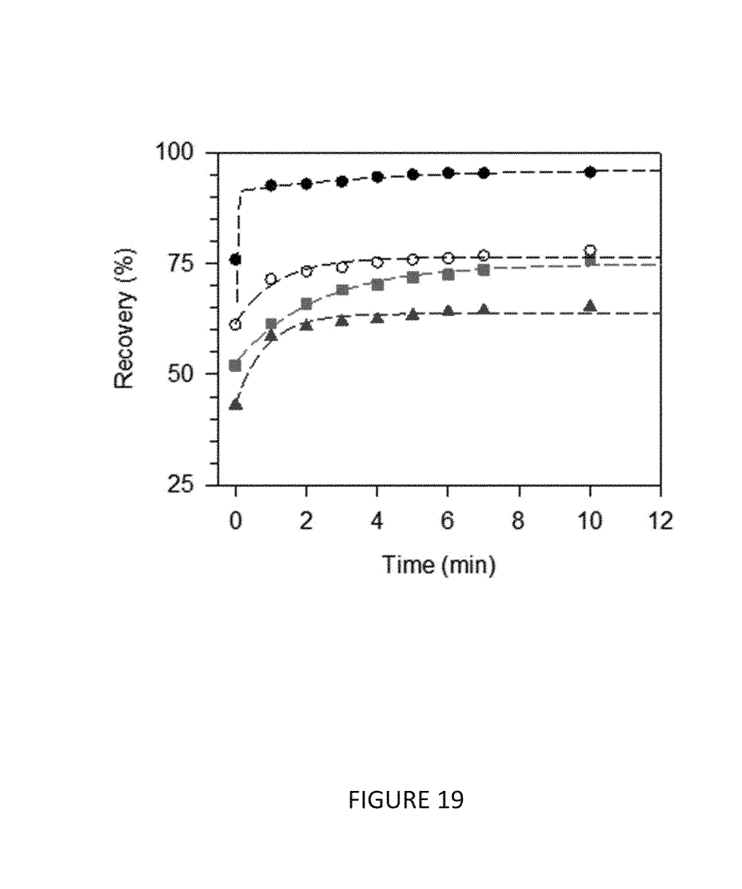

FIG. 19 shows the percentage of recovery of flexible MSBO Polyol foams as a function of time. The recovery values after 24 hours are provided in Table 11. Note that more than 90% recovery was achieved after 10 min for PW-30, ˜75% for PW-45 and PWO-30, and only ˜60% recovery was achieved after 10 min for PW-140. PWO-45 and PWO-140 samples were crushed during the test, so their recovery was not measured. The flexible foams of the present work compare very favorably with the flexible foams prepared with the polyols from the metathesized triacylglycerol of palm oil (PMTAG Polyol Foam in Table 11). Higher recovery percentage were recorded for comparatively much lower strength foams.

### SEM of MSBO PU Foam

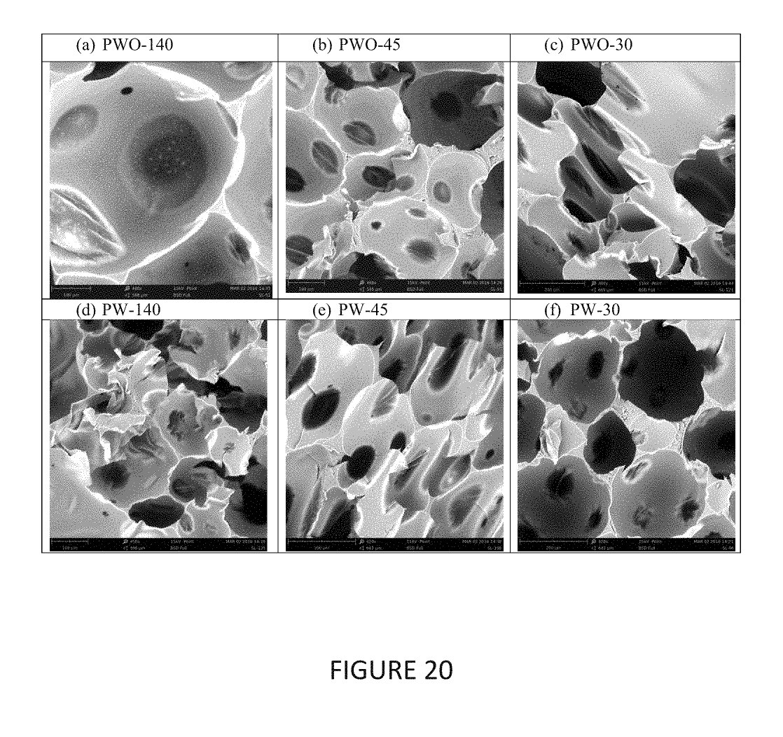

SEM images of the MSBO polyurethane foams are presented in FIG. 20. The cell size and cell density estimated from the SEM are provided in Table 12.

TABLE 12
Cell size and cell density estimated from the SEM of MSBO
polyurethanes foams, OH-value of the polyol used in the foam
formulation and density of the foams. The cell size reported in
the table is along the largest axis of the cell.

| | | OH- | Foam density | Cell size | Cell density |
|---|---|---|---|---|---|
| | Sample | value | (kg/m³) | (μm) | (cell/mm²) |
| a | PWO-140 | 263 | 159 | 540 | 4 |
| b | PWO-45 | 233 | 157 | 230 ± 32 | 20 |
| c | PWO-30 | 169 | 161 | 144 ± 31 | 16 |
| d | PW-140 | 203 | 144 | 161 ± 11 | 16 |
| e | PW-45 | 156 | 167 | 200 ± 15 | 16 |
| f | PW-30 | 99 | 157 | 260 ± 14 | 20 |

As can be seen in FIG. 20, PWO-30 and PW-45 presented elliptical cells, rather than the common round cells presented by the other foams. One can notice the very large cells of PWO-140 (FIG. 20a) and the broken cell structure of PWO-45 (. 20 b). These two structures in fact were not flexible foams as they did break under compression test. The cell size of the flexible foams obtained from MSBO polyols (Table 12) decreases with the increase of the OH-value and related crosslinking density. The cell density as estimated from the total number of cell was not affected by the OH-value. Recall that PWO-140 and PWO-45 were not flexible foams and do not adhere to this trend.

The cell size of the present MSBO PU flexible foams (140 to 260 μm) is much lower than the 386-μm of the flexible foams with comparable density prepared from PMTAG derived polyols [Pillai, P. K. S., Li, S., Bouzidi, L., and Narine, S. S. (2016); Metathesized palm oil: Fractionation strategies for improving functional properties of lipid-based polyols and derived polyurethane foams, Industrial Crops and Products 84, 273-283].

1. A method of making a natural oil-derived polyol, the method comprising:
providing a metathesized natural oil composition, which comprises metathesis oligomers of unsaturated natural oil glycerides, wherein the metathesis oligomers comprise one or more carbon-carbon double bonds, and are formed by reacting two or more unsaturated natural oil glycerides in the presence of a metathesis catalyst; and
reacting at least one of the one or more carbon-carbon double bonds in the metathesis oligomers to form a polyol.

2. The method of claim 1, wherein the unsaturated natural oil glycerides are triacylglycerides, diacylglycerides, monoacylglycerides, or any mixtures thereof.

3. The method of claim 2, wherein the unsaturated natural oil glycerides are triacylglycerides.

4. The method of claim 1, wherein the unsaturated natural oil glycerides are unsaturated glycerides of a natural oil selected from the group consisting of: a vegetable oil, an algal oil, a fish oil, an animal fat, a tall oil, and any mixtures thereof.

5. The method of claim 4, wherein the unsaturated natural oil glycerides are unsaturated glycerides of a vegetable oil.

6. The method of claim 5, wherein the vegetable oil is selected from the group consisting of: canola oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, castor oil, and any mixtures thereof.

7. The method of claim 6, wherein the vegetable oil is canola oil, palm oil, soybean oil, or a mixture thereof.

8. The method of claim 7, wherein the vegetable oil is soybean oil.

9. The method of claim 1, wherein the metathesis oligomers comprise from 2 to 20 unsaturated natural oil glyceride units.

10. The method of claim 9, wherein the metathesis oligomers comprise from 2 to 10 unsaturated natural oil glyceride units.

11. The method of claim 1, wherein the metathesis oligomers are formed by reacting two or more unsaturated natural oil glycerides in the presence of a metathesis catalyst, followed by a partial hydrogenation of its carbon-carbon double bonds.

12. The method of claim 1, wherein the metathesized natural oil composition further comprises unsaturated natural oil glyceride monomers, which have one or more carbon-carbon double bonds.

13. The method of claim 12, wherein the reacting further comprises at least one of the one or more carbon-carbon double bonds in the unsaturated natural oil glyceride monomers to form a polyol.

14. The method of claim 1, wherein the reacting comprises epoxidizing at least one of the one or more carbon-carbon double bonds in the metathesis oligomer, followed by hydroxylating at least a portion of the epoxide groups formed by the epoxidizing step.

15. The method of claim 1, wherein the polyol has a hydroxyl value of no greater than 250 mg KOH/g, or no greater than 225 mg KOH/g, or no greater than 200 mg KOH/g.

16. The method of claim 1, wherein the polyol has an onset temperature of crystallization of no greater than 30° C., or no greater than 25° C., or no greater than 22° C., or no greater than 20° C., or no greater than 18° C., or no greater than 15° C.

17. A polyol, which is made by the method of claim 1.

18. A method of forming a polyurethane composition, comprising:
providing the polyol of claim 17 and an organic diisocyanate; and
reacting the polyol and the organic diisocyanate to form a polyurethane composition.

19. The method of claim 18, wherein the organic diisocyanate is 4,4′-methylene diphenyl diisocyanate (MDI).

20. The method of claim 18, wherein the reacting occurs in the presence of one or more additives selected from the group consisting of: cross-linking compounds, chain-extending compounds, catalysts, blowing agents, and cell stabilizers.
